(19) United States
(12) Patent Application Publication
(10) Pub. No.: US 2024/0366469 A1
(43) Pub. Date: Nov. 7, 2024

(54) DEVICES AND SYSTEMS FOR PROVIDING COMPRESSION AND/OR VIBRATORY FORCES TO TISSUES

(71) Applicants: CARILION CLINIC, Roanoke, VA (US); VIRGINIA POLYTECHNIC INSTITUTE AND STATE UNIVERSITY, Blacksburg, VA (US)

(72) Inventors: Tara Newberry, Roanoke, VA (US); Leah Thomas, Blacksburg, VA (US); Laura Wenger, Blacksburg, VA (US); Seth Jarvis, Blacksburg, VA (US); Christopher Arena, Blacksburg, VA (US); Andre Muelenaer, Blacksburg, VA (US)

(21) Appl. No.: 18/415,117

(22) Filed: Jan. 17, 2024

Related U.S. Application Data
(63) Continuation-in-part of application No. PCT/US22/37612, filed on Jul. 19, 2022.
(60) Provisional application No. 63/342,377, filed on May 16, 2022.
(60) Provisional application No. 63/223,492, filed on Jul. 19, 2021.

(51) Int. Cl. A61H 23/02; A61H 23/04

(52) U.S. Cl. CPC A61H 23/0263; A61H 23/04; A61H 2201/1215; A61H 2201/1246; A61H 2201/1607; A61H 2201/1616; A61H 2201/1621; A61H 2201/1626; A61H 2201/1638; A61H 2201/1642; A61H 2201/1645; A61H 2201/165; A61H 2201/169; A61H 2201/5007; A61H 2201/5071; A61H 2201/5084; A61H 2205/02; A61H 2205/062; A61H 2205/067; A61H 2205/081; A61H 2205/083; A61H 2205/084; A61H 2205/086; A61H 2205/102; A61H 2205/106; A61H 2205/108; A61H 2205/12; A61H 2230/65

(57) ABSTRACT

Devices that can provide a compressive force and a vibratory force to treat an area are described. In some configurations, the devices can include a substrate that can provide the compressive force and multiple independently controllable actuators that can provide the vibratory force to treat swelling, lymphedema or other conditions.

### PRIORITY APPLICATIONS

This application is a continuation-in-part of PCT/US22/37612 filed on Jul. 19, 2022. PCT/US22/37612 claims priority to and the benefit of each of U.S. Provisional Application No. 63/223,492 filed on Jul. 19, 2021 and U.S. Provisional Application No. 63/342,377 filed on May 16, 2022, the entire disclosure of each of which is hereby incorporated herein by reference for all purposes.

### TECHNOLOGICAL FIELD

Aspects and configurations described herein relate to devices and systems that can be used to provide compressive and/or vibratory forces to an area of a mammal in need of treatment. More particularly, aspects relate to devices, methods and systems that can be used to treat lymphedema.

### BACKGROUND

Tissue swelling often is a result of different disorders or medical treatments. It is difficult to treat swelling of tissues directly. In many instances, systemic diuretics are given to reduce overall fluid volume.

### SUMMARY

Various aspects and features are described in reference to a device that can provide one or more of compression, vibratory forces or both to treat an area of a mammal.

In an aspect, a device comprises a substrate configured to contact an area of a mammal, and one or more individually controllable actuators, e.g., a plurality of individually controllable actuators, in the substrate, wherein the one or more actuators or the plurality of the individually controllable actuators are each configured to provide a vibratory force to a portion of the contacted area of the mammal.

In some embodiments, the device comprises a processor electrically coupled to the one or more individually controllable actuators. In certain embodiments, the processor is programmed to actuate actuators distal from a trunk of the mammal at a higher frequency or to provide a greater vibratory force than actuators proximate to the trunk of the mammal.

In other embodiments, the substrate is configured to provide a compressive force to the area of the mammal contacted by the substrate. In some configurations, substrate is conformable.

In certain embodiments, the substrate is configured as a wrap comprising a fastener to retain the wrap around the area.

In other embodiments, the device can include a temperature control device in the substrate, wherein the temperature control device is electrically coupled to the processor.

In some configurations, the vibratory force is configured as a non-percussive vibratory force.

In some examples, at least one of the individually controllable actuators comprises a linear resonant actuator.

In other examples, the substrate comprises a cooling material.

In certain configurations, at least one of the individually controllable actuators provides a vibratory frequency to the contacted area from about 10 Hz to about 300 Hz.

In some embodiments, the processor is configured to vary an intensity of the vibratory force to reduce swelling at the contacted area.

In some embodiments, the device can include a pressure sensor within the substrate, wherein the pressure sensor is electrically coupled to the processor and is configured to monitor pressure at the contacted area. In other embodiments, the device can include an accelerometer within the substrate, wherein the accelerometer is electrically coupled to the processor and is configured to monitor a frequency of the vibratory forces provided by plurality of individually controllable actuators. In some instances, the device can include a bioimpedance sensor in the substrate, wherein the bioimpedance sensor is configured to monitor fluid content at the contacted area.

In some embodiments, at least one of the individually controllable actuators comprises one or more of a linear resonant actuator, a piston, an eccentric rotating mass vibration motor, a linear rotor, a piezoelectric disk or a hydraulic device. Each actuator need not be the same but can be the same if desired.

In some examples, at least one of the individually controllable actuators is configured as a MEMS device.

In certain embodiments, a position of the individually controllable actuators within the substrate is variable. For example, the actuator can be moved from a first site to a second site.

In some examples, the substrate comprises a reverse gelling material to increase compression at the contacted area when the reverse gelling material is heated by the contacted area or by the substrate.

In some examples, the substrate is configured to contact external surfaces of an organ of the mammal, whereas in other instances, the substrate is configured to contact internal surfaces of the mammal.

In some embodiments, the substrate is configured as a wrap to surround the contacted area at a neck, head, arm, hand, leg, foot or trunk of the mammal.

In other embodiments, the substrate is configured as a sleeve to surround the contacted area at a neck, arm, hand, foot, leg or trunk of the mammal.

In certain examples, the substrate is configured as a sock or a vest or an undergarment or other devices that a mammal such as a human can wear.

In some configurations, the device can include a power source integral to the substrate.

In other configurations, the device can include at least one interconnect configured to electrically couple the processor and the individually controllable actuators to an external power source.

In some embodiments, the device can include an antenna. In other embodiments, the device can include a computer readable medium electrically coupled to the processor, wherein the computer readable medium has instructions stored thereon, wherein the instructions, when executed by the processor, cause the processor to independently actuate the individually controllable actuators to provide the vibratory force at the contacted area.

In another aspect, a device for reducing swelling at a swollen area of a mammal comprises a substrate configured to contact and apply compression to the swollen area of a mammal, one or more individually controllable actuators in the substrate, wherein the individually controllable actuators are each configured to provide a vibratory force to a portion of the compressed, swollen area of the mammal, a processor electrically coupled to the individually controllable actuators, and a computer readable medium electrically coupled to the processor, wherein the computer readable medium has instructions stored thereon, wherein the instructions, when executed by the processor, cause the processor to independently actuate the individually controllable actuators to provide the vibratory force and reduce swelling at the compressed, swollen area of the mammal.

In some configurations, the substrate is configured as a wrap comprising a fastener to retain the wrap around the compressed, swollen area of the mammal. In other configurations, the substrate is configured as a sleeve to encompass the compressed, swollen area of the mammal. In some embodiments, the processor is programmed to actuate actuators distal from a trunk of the mammal at a higher frequency than actuators proximate to the trunk of the mammal. In other embodiments, at least one of the individually controllable actuators comprises a linear resonator actuator. In some examples, the substrate comprises a cooling material.

In certain configurations, at least one of the individually controllable actuators provides a vibratory frequency from about 10 Hz to about 300 Hz to the portion of the compressed, swollen area of the mammal.

In some embodiments, the substrate is configured as a sock, a vest, an arm sleeve, a leg sleeve, a head/neck wrap or an undergarment. In other embodiments, the device comprises a power source integral to the substrate or external to the substrate.

In some examples, the device comprises at least one interconnect configured to electrically couple the processor and the individually controllable actuators to an external power source.

In an additional aspect, the devices described herein can be used to reduce swelling at a swollen area of a mammal by applying the device to contact the swollen area of the mammal, and actuating the individually controllable actuators to reduce the swelling at the contacted, swollen area of the mammal.

In another aspect, a devices described herein can be used to enhance athletic performance by applying the device to contact an area of a mammal, and actuating the individually controllable actuators to increase internal fluid flow at the contacted area of the mammal.

In an additional aspect, a devices described herein can be used to reduce swelling at an area of a mammal with lymphedema by applying the device to contact the area of the mammal with lymphedema, and actuating the individually controllable actuators to reduce the swelling at the contacted area of the mammal with lymphedema.

In another aspect, a system can include any of the devices described herein in combination with written or electronic instructions for using the device to treat swelling or to treat lymphedema or to treat edema or to treat other conditions.

In another aspect, a system can include a device and instructions for use of the device during an imaging procedure. For example, the device can be used to retain an agent, therapeutic or other material between two areas during imaging and/or treatment.

In an additional aspect, a system can include any of the devices described herein in combination with written or electronic instructions for using the device to enhance athletic performance.

In another aspect, a non-transitory computer readable medium having instructions stored thereon, wherein the instructions, when executed by a processor, cause the processor to actuate individually controllable actuators in a substrate, wherein the individually controllable actuators are each configured to provide a vibratory force to a portion of an area of a mammal contacted by the substrate is described.

In some embodiments, the instructions, when executed by the processor, cause the processor to actuate actuators distal from a trunk of the mammal at a higher frequency or to provide a greater vibratory force than actuators proximate to the trunk of the mammal.

In other embodiments, the instructions, when executed by the processor, cause the processor to vary the vibratory force provided by the individually controllable actuators to reduce swelling at the area of the mammal contacted by the substrate.

In an aspect, a device for reducing swelling at an area of a mammal using gradient vibratory forces simultaneously with compression at the area of the mammal comprises a substrate configured to contact and provide a compressive force to the area of a mammal, one or more individually controllable actuators in the substrate, wherein the individually controllable actuators are each configured to provide a vibratory force to a portion of the compressed, area of the mammal, and wherein individually controllable actuators at distal areas from a trunk of the mammal are configured to provide a greater vibratory force than individually controllable actuators at proximate areas from the trunk of the mammal, a processor electrically coupled to the individually controllable actuators, and a computer readable medium electrically coupled to the processor, wherein the computer readable medium has instructions stored thereon, wherein the instructions, when executed by the processor, cause the processor to independently actuate the individually controllable actuators to provide the gradient vibratory force to reduce swelling at the compressed, area of the mammal.

In some embodiments, at least one of the individually controllable actuators comprises a linear resonant actuator. In other embodiments, each of the individually controllable actuators is a linear resonant actuator

In some examples, the substrate is configured as a wrap to surround the contacted area at a neck, head, arm, hand, leg, foot or trunk of the mammal. In additional examples, the substrate is configured as a sleeve to surround the contacted area at a neck, arm, hand, foot, leg or trunk of the mammal. In some examples, the substrate is configured as a sock or a vest or an undergarment or other garments which can be worn by a human or non-human mammal.

In certain embodiments, the device comprises at least one interconnect configured to electrically couple the processor and the individually controllable actuators to an external power source.

In other embodiments, the substrate comprises a cooling material.

In some configurations, each actuator can be placed within a material to disperse the vibratory force over a larger area. In certain examples, the material comprises a silicone.

In another aspect, a method of stimulating tissues comprising applying any of the devices described herein to contact an area of a mammal, actuating individually controllable actuators and applying percussive massage to areas of the mammal to increase internal fluid flow at the contacted area of the mammal.

In some embodiments, the percussive massage is applied before the individually controllable actuators are actuated. In other embodiments, the percussive massage is applied after the individually controllable actuators are actuated. In additional embodiments, the percussive massage is applied simultaneously with actuation of the individually controllable actuators.

### BRIEF DESCRIPTION OF THE FIGURES

Certain aspects are described with reference to the accompanying figures in which:

FIG. 1 is an illustration showing a head/neck wrap that provides compression;

FIG. 2 is an illustration showing a leg sleeve that provides compression;

FIG. 3 is an illustration showing a sock that provides compression;

FIG. 4 is an illustration showing a glove that provides compression;

FIG. 5 is an illustration showing an arm sleeve that provides compression;

FIG. 6 is an illustration showing underwear that provides compression;

FIG. 7 is another illustration showing underwear that provides compression;

FIG. 8 is an illustration showing a vest that provides compression;

FIG. 9 is a block diagram showing two actuators in a substrate;

FIG. 10 is an illustration showing four actuators in a substrate;

FIG. 11 is an illustration showing twelve actuators in a substrate;

FIG. 12 is an illustration showing sixteen actuators in a substrate;

FIG. 13 is an illustration showing thirty-two actuators in a substrate;

FIG. 14 is an illustration showing a substrate with grid actuators which can be independently controlled;

FIG. 15 is an illustration showing a head/neck wrap that provides a vibratory force and optionally compression;

FIG. 16 is an illustration showing a leg sleeve that provides a vibratory force and optionally compression;

FIG. 17 is an illustration showing a sock that provides a vibratory force and optionally compression;

FIG. 18 is an illustration showing a glove that provides a vibratory force and optionally compression;

FIG. 19 is an illustration showing an arm sleeve that provides a vibratory force and optionally compression;

FIG. 20 is an illustration showing underwear that provides a vibratory force and optionally compression;

FIG. 21 is an illustration showing a vest that provides a vibratory force and optionally compression;

FIG. 22 is a block diagram showing a device including a substrate, an actuator and a processor in the substrate;

FIG. 23 is a block diagram showing a device including a substrate, an actuator and a processor external to the substrate;

FIG. 24 is a graph showing a constant compressive force provided by a substrate during a treatment time;

FIG. 25 is a graph showing a decreasing compressive force provided by a substrate during a treatment time;

FIG. 26 is a graph showing an increasing compressive force provided by a substrate during a treatment time;

FIG. 27 is a graph showing a step-wise increase in compressive force during treatment;

FIG. 28 is a graph showing a non-linear change in compressive force during treatment;

FIG. 29 is a graph showing a sinusoidal change in compressive force during treatment;

FIG. 30 is graph showing an increase in compressive force distally from a trunk of a mammal;

FIG. 31 is graph showing a decrease in compressive force distally from a trunk of a mammal;

FIG. 32 is a graph showing compressive force that is higher in distal regions of a substrate;

FIG. 33 is a graph showing a constant average vibratory force for a specific actuator during treatment;

FIG. 34 is a graph showing a decreasing average vibratory force for a specific actuator during treatment;

FIG. 35 is a graph showing an increasing average vibratory force for a specific actuator during treatment;

FIG. 36 is a graph showing sinusoidal pulsing to change a vibratory force provided by an actuator;

FIG. 37 is a graph showing square pulsing to change a vibratory force provided by an actuator;

FIG. 38 is a graph showing trapezoidal pulsing to change a vibratory force provided by an actuator;

FIG. 39 is a graph showing an increase in vibration frequency for different actuators as distance from a trunk of a mammal increases;

FIG. 40 is a graph showing a decrease in vibration frequency for different actuators as distance from a trunk of a mammal increases;

FIG. 41 is a graph showing higher vibration frequencies for actuators at distal areas of a substrate;

FIG. 42 is a block diagram showing a temperature device in combination with an actuator;

FIG. 43 is a block diagram showing a pressure sensor in combination with an actuator;

FIG. 44 is a block diagram showing an accelerometer in combination with an actuator;

FIG. 45 is a block diagram showing a bioimpedance sensor in combination with an actuator;

FIG. 46 is a block diagram showing an oxygen sensor in combination with an actuator;

FIG. 47 is a block diagram showing an antenna in combination with an actuator;

FIG. 48 is an illustration showing a substrate with independent sites which can receive an actuator;

FIG. 49 shows an illustration where actuators can be placed to treat lymphedema of the head and neck;

FIG. 50 is a graph showing measured acceleration as a function of distance for a large vibratory device at a low setting;

FIG. 51 is a graph showing frequency as a function of distance for a large vibratory device at a low setting;

FIG. 52 is a graph showing measured acceleration as a function of distance for a large vibratory device at a high setting;

FIG. 53 is a graph showing frequency as a function of distance for a large vibratory device at a high setting;

FIG. 54 is a graph showing measured acceleration as a function of distance for a small vibratory device;

FIG. 55 is a graph showing frequency as a function of distance for a small vibratory device;

FIG. 56 is a graph showing measured acceleration as a function of distance for one tested motor; and

FIG. 57 is a graph showing frequency as a function of distance for one tested motor.

### DETAILED DESCRIPTION

Certain devices described herein can be used to provide one or more of compressions, vibratory forces or both to an area of a mammal in need of treatment. The exact disorder or reason for treatment can vary, e.g., the devices, methods and systems can be used to reduce swelling and/or enhance flow of fluids out of areas contacted by the devices, to treat pain using vibration compression or both, etc. For example, lymphedema, tendonitis, arthritis, bursitis, athletic performance or inflammatory disorders can be treated with the devices and methods described herein. While the exact configuration of the device can vary, some configurations use compression in combination with a vibratory force to reduce swelling, reduce lymphedema or otherwise promote fluid flow out of (and/or into) a particular region of a tissue or an organ of a mammal. Similar configurations can be used to provide pain relief using vibration, compression or both. Promotion of lymphatic drainage using the devices can be particularly desirable. Lymphedema is an abnormal buildup of protein rich fluid that can result in swelling. The efficacy of treatment can be monitored in an automated manner, e.g., using one or more sensors or devices, or manually, e.g., by manual measurement of the circumference of the area to be treated. Humans, primates, horses, dogs, cats or other mammals can be treated using the devices, methods and systems described herein.

Head and neck cancer comprises 4% of all cancers in the U.S., affecting an estimated 66,6630 people in 2021. Moreover, head and neck cancer will cause an estimated 14,620 deaths this year in the United States There are five main types of head and neck cancers: laryngcal and hypopharyngeal cancer, nasal cavity, and paranasal sinus cancer, nasopharyngeal cancer, oral and oropharyngeal cancer, and salivary gland cancer. These cancers are distinguished from other types of cancer affecting the head and neck region, as the diagnosis and treatment are significantly different.

According to the American Head and Neck Society, lymphedema is the swelling of soft tissues due to the accumulation of lymph. Lymph contains water primarily, along with proteins, chemicals, and white blood cells. Because surgery and radiation treatment for cancer of the head and neck region can interrupt the normal collection of lymph by the lymphatic system, lymph can accumulate in these tissues and cause lymphedema. For example, lymphedema often occurs 2-6 months after a patient's surgery or treatment and can be internal or external, or both. Internal lymphedema occurs inside the body, such as the oral cavity, tongue, larynx, airway, and throat. In contrast, external lymphedema occurs in the neck and face, including lips, nose, eyelids, cars, etc.

Lymphedema is very common and occurs in up to 75% of patients with head and neck surgery or radiation treatment. Lymphedema is diagnosed by a clinician who can distinguish the types of swelling. It can also be rated on a scoring system, such as the Foldi Scale or the MD Anderson Cancer Center Head and Neck Lymphedema Scale. For example, stage 0 corresponds to No swelling, but a sense of heaviness in the neck. Stage 1a corresponds to visible mild swelling without pitting and is reversible. Stage 1b corresponds to visible mild swelling with pitting and is reversible. Stage 2 corresponds to firm pitting swelling that is irreversible but without visible tissue changes. Stage 3 corresponds to irreversible tissue changes with scarring and fibrosis. Face and neck measurements may also be taken to track the progression of lymphedema, and endoscopy may be used to evaluate internal lymphedema.

In certain embodiments, the devices described herein can be configured with a substrate that can wrap around, encompass or otherwise contact some area of a mammal to be treated. In some embodiments, the substrate can provide compression to the contacted area. For example, the substrate may wrap around the area and attach to itself to provide some compressive force to the area in need of treatment. In other instances, the substrate may be configured as a sleeve that can be put in place around a tissue or organ to provide the compression. In additional instances, the substrate may be configured as a bandage that can compress an underlying area to at least some degree. Additional configurations including socks, gloves, jackets, undergarments, etc. are discussed in more detail below. The exact level of compression that is provided can vary, and in some instances the device can be wrapped tightly around the area so the patient feels some pressure in the area. The pressure can be increased or decreased as desired and may vary during treatment.

In certain configurations, the substrate need not provide the same compressive force at all areas. For example, the compressive force at one area of the substrate may be greater than a compressive force at another area. While not used in all instances or used to treat all conditions, in one configuration the compressive force provided at an area more distal from a trunk of the mammal may be greater than a compressive force provided at an area more proximate to the trunk of the mammal. If desired, however, the compressive force provided by all areas of the substrate may be the same or about the same. The compressive force may also be altered or vary during treatment of an area. For example, a reverse gelling material, e.g., a reverse gelling hydrogel or other material, which becomes more viscous as it is heated, can be present in the substrate. As the area to be treated heats the substrate, the compressive force can increase as the gel is heated and becomes more viscous. In other instances, additional substrate layers may be wrapped around or placed on the area to increase the compression during the treatment.

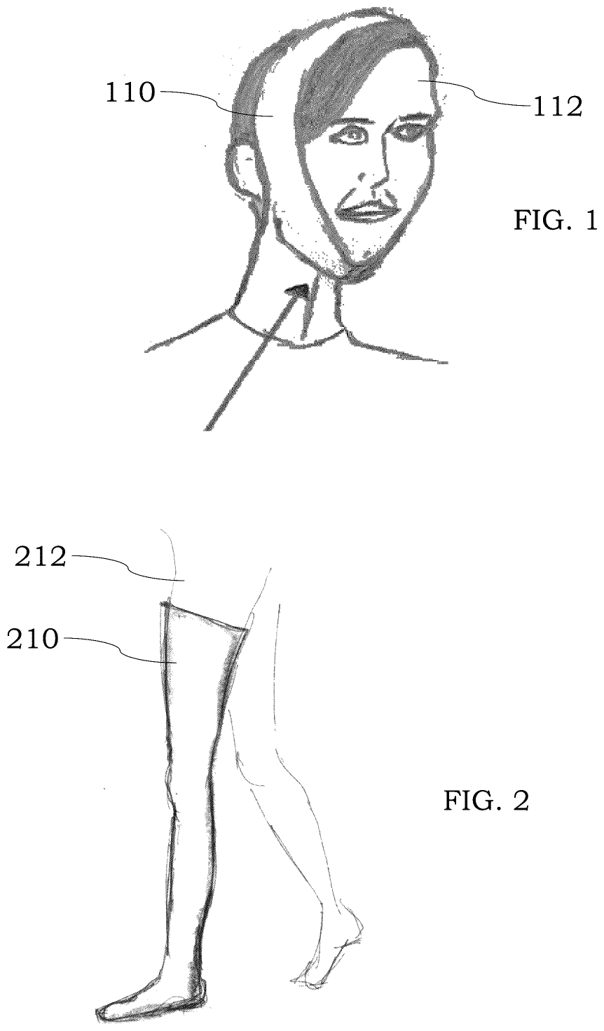

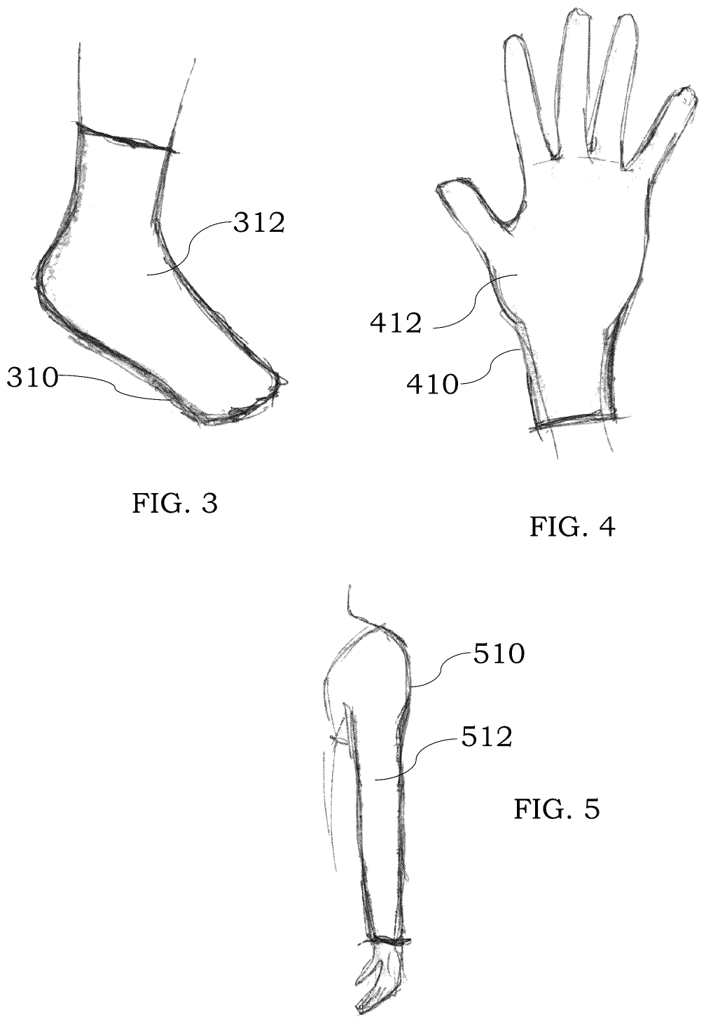

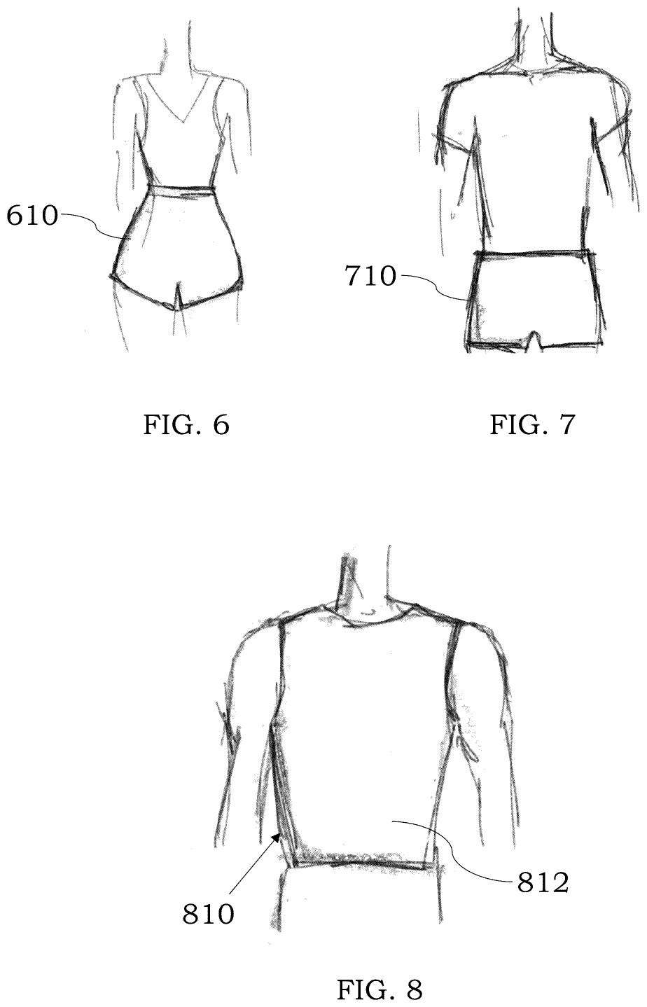

As noted above, the exact configuration of a substrate that can provide a compressive force may vary. Referring to FIG. 1, a head/neck wrap 110 that provides compression to the head/neck area is shown wrapped around a head 112 of a patient. A leg sleeve 210 that provides compression to a leg 212 is shown in FIG. 2. A sock 310 that provides compression to the foot/ankle area 312 is shown in FIG. 3. A glove 410 that provides compression to the hand 412 is shown in FIG. 4. An arm sleeve 510 that provides compression to the arm 51 is shown in FIG. 5. Underwear 610 that provides compression to the genital area is shown in FIG. 6. A different configuration of an undergarment 7100 that provide compression to the genital area is shown in FIG. 7. A vest 810 that provides compression to the torso 812 of a patient is shown in FIG. 8. The illustrative configurations shown in FIGS. 1-8 can provide a constant compressive force or a variable compressive force as desired.

In certain embodiments, the substrate can include one or more fasteners to maintain the compressive force around the contacted area. For example, the devices may be retained in place using suitable fasteners and means including, for example, hook and loop fastener, double sided tape, straps, films or other means to assist in placement and retention of the device around or at an area.

The exact material present in the substrate may vary. Illustrative materials include, but are not limited to, fabrics, polymers, polyesters, cotton, materials with natural fibers, materials with synthetic fibers, cooling materials, heat-sensitive materials, porous materials, non-porous materials, conformable materials and other materials which can be made into a garment, wrap, bandage, strip or the like.

In certain configurations, the substrates described herein may comprise one or more motors or actuators configured to provide a vibratory force to an area of contacted by the substrate. While certain configurations use both compression and a vibratory force during treatment, some embodiments may provide only a vibratory force without any substantial compression from the substrate. For example, pain relief using only vibratory forces may be implemented if desired. The actuator generally provides a non-percussive force to avoid damage to the area provided with the vibratory force. The vibratory force generally does not strike the area but provides a gentle force to promote movement of fluid into and/or out of the area. The vibratory force can act to provide a force to the area in addition to any pressure provided from the substrate. Simultaneous application of compression and vibratory forces can provide more effective treatment than either stimulus alone.

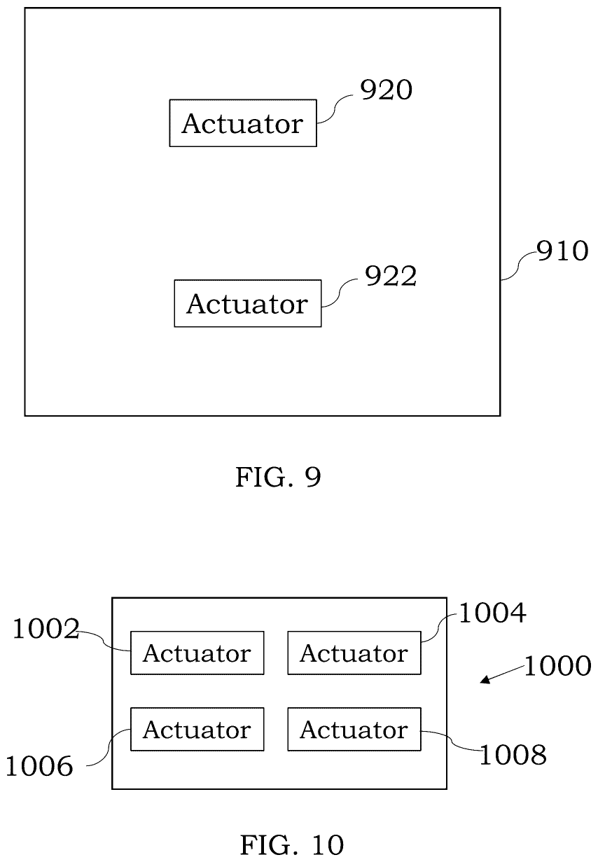

A general schematic of a device including a substrate 910 including two actuators 920, 922 is shown in FIG. 9. As noted herein, only a single actuator could be present if desired to provide localized or “spot” treatment of an area. The actuators 920, 922 are independently controllable so a frequency, amplitude, force, etc. provided by each of the actuators 920, 922 can be the same or can be different. In some instances, the force provided by the actuators 920, 922 is the same, and the frequency may by the same or different. For example, the actuator 920 can be actuated at a higher vibratory frequency than the actuator 922. The exact vibratory frequency selected may vary, and illustrative vibratory frequencies range from about 10 Hz to about 300 Hz, more particularly about 50 Hz to about 200 Hz. Depending on how the actuators are controlled, different frequencies can be used. For example, where the actuators take the form of a motor, the motor can be controlled using pulse width modulation that may have a frequency from about 100 Hz to about 20 KHz.

In some embodiments, the force provided by the actuators 920, 922 may be different. For example, it may be desirable to provide a force of greater magnitude using the actuator 920 than a force provided by the actuator 922. As noted in more detail below, a force provided by an actuator more distal from a trunk of a mammal may be greater than a force provided by an actuator more proximate to the trunk of the mammal. The forces may also be varied during treatment.

In other embodiments, a force provided by the actuators 920, 922 may be the same but a vibratory frequency provided by the actuators 920, 922 may be different. For example, a vibratory frequency of one of the actuators 920, 922 can be higher than the other actuator. In some instances, a vibratory frequency provided by an actuator more distal from a trunk of a mammal may be higher than a vibratory frequency provided by an actuator more proximate to the trunk of the mammal. The vibratory frequencies can be varied during treatment as desired.

In certain configurations, both a force and a vibratory frequency of different actuators can be different. For example, a force and a vibratory frequency provided by the actuator 920 can be different than a force and vibratory frequency provided by the actuator 922. If desired, however, during treatment, the force and/or vibratory frequency of the actuators 920, 922 may be the same or similar at some period during treatment. Where a single actuator is used, the force and/or frequency provided by the single actuator may be varied during treatment.

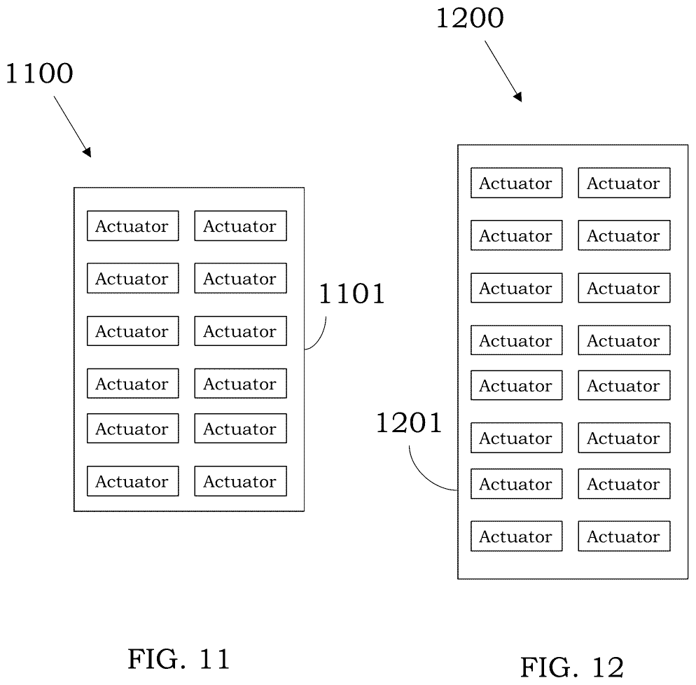

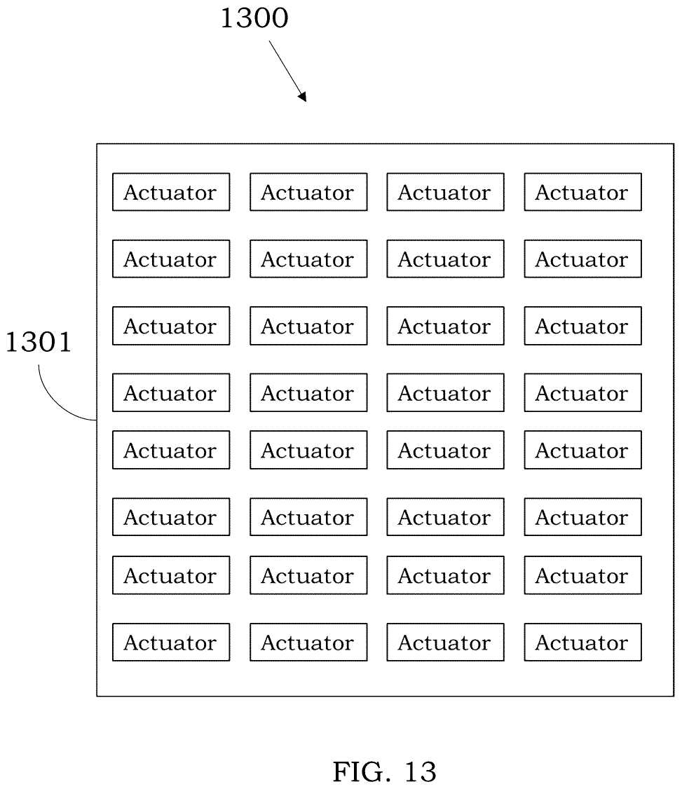

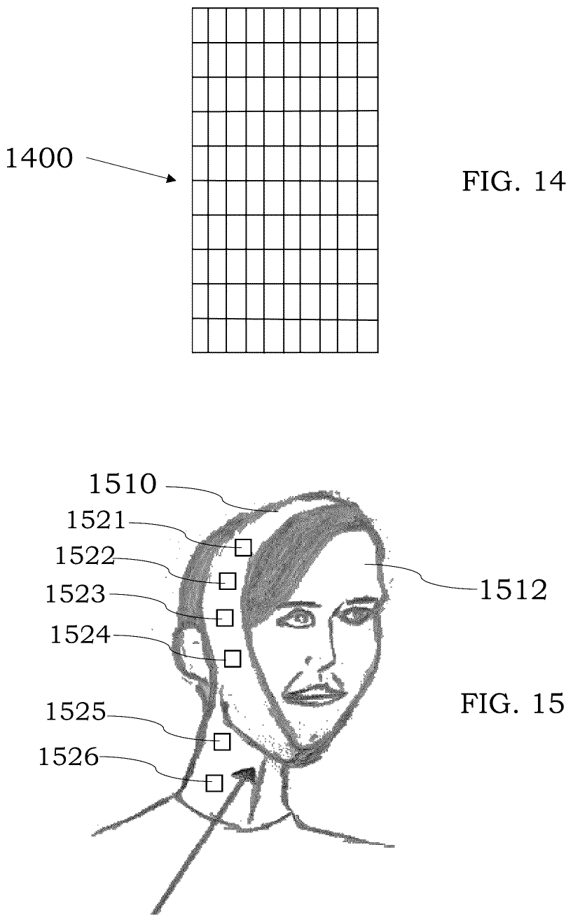

In certain embodiments, the exact number of actuators present in the substrate may vary from one, two to several dozen or more, e.g., 2 to 100 actuators can be present depending on the overall size of the actuator, the vibratory force to be provided and the size of the area to be treated. In some instances, a device can include 2 to 24 actuators or 2 to 16 actuators or 2 to 12 actuators, e.g., 2, 3, 4, 5, 6, 7, 8, 9, 10, 11 or 12 actuators. The particular number of actuators used may be selected to promote a desired treatment level over a desired treatment period. The spacing between actuators may vary as noted in more detail below. Illustrative configurations are shown in FIG. 10 (a device 1000 with four actuators 1002, 1004, 1006, 1008 in a substrate 1001), FIG. 11 (a device 1100 with twelve actuators in a substrate 1101), FIG. 12 (a device 1200 with 16 actuators in a substrate 1201) and FIG. 13 (a device 1300 with 32 actuators in a substrate 1301). If desired, the substrate may have a plurality of individual actuators with one or more actuator present in a cell of a grid as shown in the device 1400 of FIG. 14. Each cell of the device 1400 can be individually controllable as noted herein.

The devices described herein can have the actuators arranged symmetrically, asymmetrically, linearly, radially, coaxially or in other manners. The exact arrangement may vary depending on the particular configuration of the device and desired areas where a vibratory force is to be provided. Each actuator may have an address which can be used by a processor to selectively activate or inactivate that particular actuator.

In certain embodiments, the actuators of the devices described herein may be configured in many different manners. For example, the actuators may be, or may include, one or more of a linear resonant actuator, a piston, an eccentric rotating mass vibration motor, a linear rotor, a piezoelectric disk, a pneumatic device (e.g., a bladder pump, vacuum pump, etc.), a hydraulic device, a MEMS device, a micromotor, a nanomotor or other devices or materials that can provide a controllable vibratory force. Linear resonant actuators (LRAs) may be particularly useful and generally include a mass attached to a spring in an arrangement similar to a speaker. The LRA can provide an audible signal that can provide the vibratory force in one or more directions. Notwithstanding that the actuator may adopt many different configurations and include many different components and materials, the actuator can provide the vibratory force mechanically, acoustically or in other manners. A device can include actuators all of which have the same configuration or can include at least two actuators with different configurations. Further, a single actuator site could include two different types of actuators that may both be actuated or where one actuator is selectively activated. Different actuators can provide different levels and types of vibratory forces, and it may be desirable to have multiple different types of actuators at each site to enhance the flexibility of the devices. The actuators can be attached to the underlying substrate, may float in the substrate or may otherwise be disposed in the substrate in some manner to permit placement of the actuator at a desired area. If desired, the actuator may be present in fiber matrix that can be used to disperse the vibratory force across a larger area.

In certain embodiments, the actuator can be used with an accessory device or other device to provide a desired vibratory force or density. For example, the actuator can be present as a pod which can distribute the vibratory force over a larger surface area to provide for more gentle delivery of the vibratory force to the contacted area. In some instances, the actuator can be present in a gel, a silicone or other materials to assist in distributing the force over a desired area.

In certain embodiments, the actuators described herein can be present in a substrate configured as a wrap, garment, bandage, etc. The substrate can provide compression or may be configured to contact an area without any substantial compression as desired. The substrate can include an adhesive or be adhesive free. Referring to FIG. 15, a head/neck wrap 1510 is shown that can wrap around the head/neck of a patient 1512. The head/neck wrap 1510 can provide a compressive force or may be loosely wrapped around the head/neck so only vibratory forces are provided. The wrap 1510 includes actuators 1521, 1522, 1523, 1524, 1525 and 1526. Fewer or more actuators can be present as desired. While not shown, actuators are typically present on posterior and anterior surfaces of the device that contacts the area to be treated. Each of the actuators 1521, 1522, 1523, 1524, 1525 and 1526 can be independently controlled and can provide the same or different vibratory force levels, can be operated at the same or different vibratory frequencies and may be electrically coupled to a processor (not shown) to control operation of each of the actuators 1521, 1522, 1523, 1524, 1525 and 1526. The actuators 1521, 1522, 1523, 1524, 1525 and 1526 can be the same or can be different. For example, each of the actuators 1521, 1522, 1523, 1524, 1525 and 1526 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

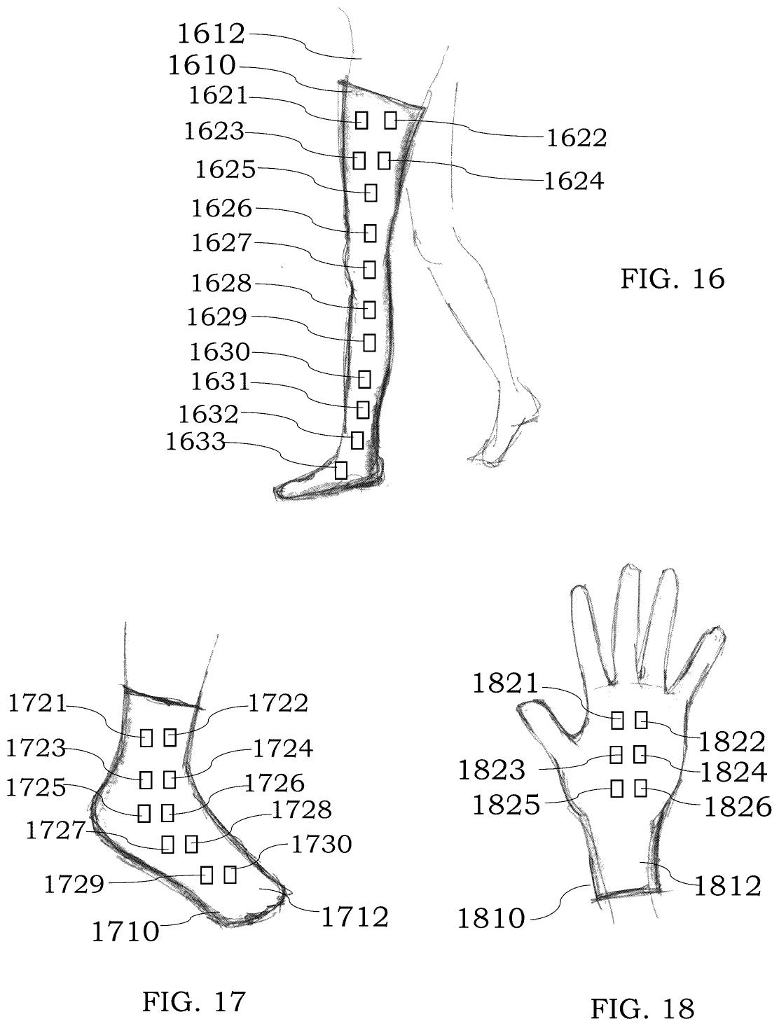

In certain examples, the actuators can be present in a leg sleeve 1610 that can be placed around a leg 1612 as shown in FIG. 16. The sleeve 1610 includes actuators 1621, 1622, 1623, 1624, 1625, 1626, 1627, 1628, 1629, 1630, 1631, 1632, and 1633. Additional actuators (not shown) are typically present on other surfaces of the sleeve 1610. Fewer or more actuators can be present as desired. While not shown, actuators are typically present on posterior and anterior surfaces of the device that contacts the area to be treated. Each of the actuators 1621, 1622, 1623, 1624, 1625, 1626, 1627, 1628, 1629, 1630, 1631, 1632, and 1633 can be independently controlled and can provide the same or different vibratory force levels, can be operated at the same or different vibratory frequencies and may be electrically coupled to a processor (not shown) to control operation of each of the actuators 1621, 1622, 1623, 1624, 1625, 1626, 1627, 1628, 1629, 1630, 1631, 1632, and 1633. The actuators 1621, 1622, 1623, 1624, 1625, 1626, 1627, 1628, 1629, 1630, 1631, 1632, and 1633 can be the same or can be different. For example, each of the actuators 1621, 1622, 1623, 1624, 1625, 1626, 1627, 1628, 1629, 1630, 1631, 1632, and 1633 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

In certain examples, the actuators can be present in a sock 1710 that can be placed around a foot 1712 as shown in FIG. 17. The sock 1710 includes actuators 1721, 1722, 1723, 1724, 1725, 1726, 1727, 1728, 1729, and 1730. Additional actuators (not shown) are typically present on other surfaces of the sock 1710. Fewer or more actuators can be present as desired. While not shown, actuators are typically present on posterior and anterior surfaces of the device that contacts the area to be treated. Each of the actuators 1721, 1722, 1723, 1724, 1725, 1726, 1727, 1728, 1729, and 1730 can be independently controlled and can provide the same or different vibratory force levels, can be operated at the same or different vibratory frequencies and may be electrically coupled to a processor (not shown) to control operation of each of the actuators 1721, 1722, 1723, 1724, 1725, 1726, 1727, 1728, 1729, and 1730. The actuators 1721, 1722, 1723, 1724, 1725, 1726, 1727, 1728, 1729, and 1730 can be the same or can be different. For example, each of the actuators 1721, 1722, 1723, 1724, 1725, 1726, 1727, 1728, 1729, and 1730 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

In certain examples, the actuators can be present in a glove 1810 that can be placed around a hand 1812 as shown in FIG. 18. The glove 1810 includes actuators 1821, 1822, 1823, 1824, 1825, and 1826. Additional actuators (not shown) are typically present on other surfaces of the glove 1810. Fewer or more actuators can be present as desired. While not shown, actuators are typically present on posterior and anterior surfaces of the device that contacts the area to be treated. Each of the actuators 1821, 1822, 1823, 1824, 1825, and 1826 can be independently controlled and can provide the same or different vibratory force levels, can be operated at the same or different vibratory frequencies and may be electrically coupled to a processor (not shown) to control operation of each of the actuators 1821, 1822, 1823, 1824, 1825, and 1826. The actuators 1821, 1822, 1823, 1824, 1825, and 1826 can be the same or can be different. For example, each of the actuators 1821, 1822, 1823, 1824, 1825, and 1826 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

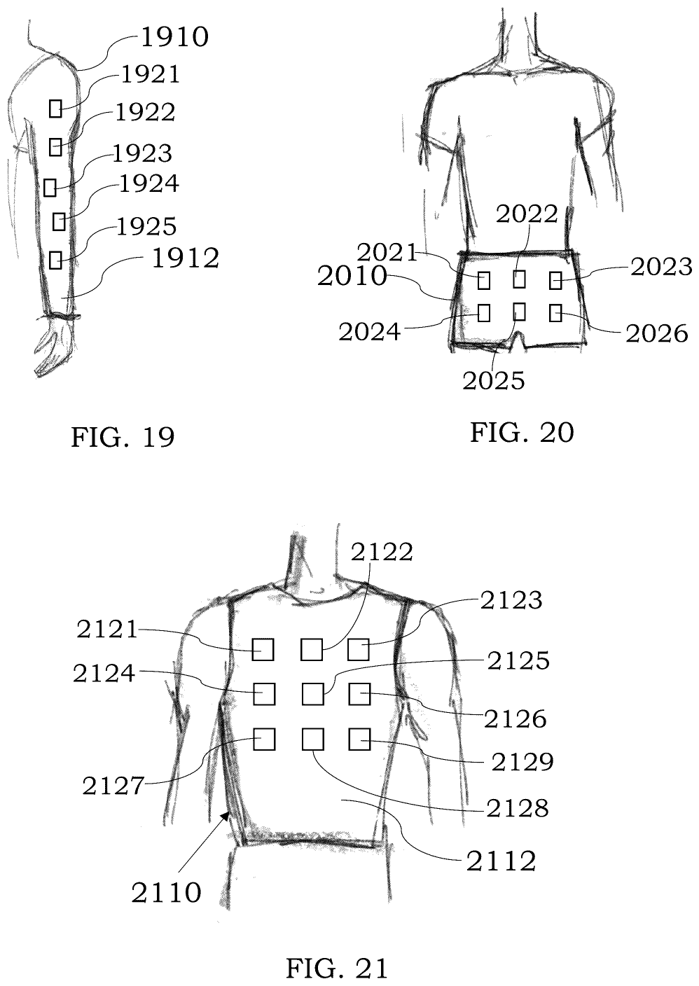

In certain embodiments, the actuators can be present in an arm sleeve 1910 that can be placed around an arm 1912 as shown in FIG. 19. The arm sleeve 1910 includes actuators 1921, 1922, 1923, 1924, and 1925. Additional actuators (not shown) are typically present on other surfaces of the arm sleeve 1910. Fewer or more actuators can be present as desired. While not shown, actuators are typically present on posterior and anterior surfaces of the device that contacts the area to be treated. Each of the actuators 1921, 1922, 1923, 1924, and 1925 can be independently controlled and can provide the same or different vibratory force levels, can be operated at the same or different vibratory frequencies and may be electrically coupled to a processor (not shown) to control operation of each of the actuators 1921, 1922, 1923, 1924, and 1925. The actuators 1921, 1922, 1923, 1924, and 1925 can be the same or can be different. For example, each of the actuators 1921, 1922, 1923, 1924, and 1925 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

In some embodiments, the actuators can be present in underwear or an undergarment 2010 that can be placed around the genital area as shown in FIG. 20. The undergarment 2010 includes actuators 2021, 2022, 2023, 2024, 2025 and 2026. Additional actuators (not shown) are typically present on other surfaces of the undergarment 2010. Fewer or more actuators can be present as desired. While not shown, actuators are typically present on posterior and anterior surfaces of the device that contacts the area to be treated. Each of the actuators 2021, 2022, 2023, 2024, 2025 and 2026 can be independently controlled and can provide the same or different vibratory force levels, can be operated at the same or different vibratory frequencies and may be electrically coupled to a processor (not shown) to control operation of each of the actuators 2021, 2022, 2023, 2024, 2025 and 2026. The actuators 2021, 2022, 2023, 2024, 2025 and 2026 can be the same or can be different. For example, each of the actuators 2021, 2022, 2023, 2024, 2025 and 2026 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

In other configurations, the actuators can be present in a vest 2110 that can be placed around the torso 2112 as shown in FIG. 21. The vest 2110 includes actuators 2121, 2122, 2123, 2124, 2125, 2126, 2127, 2128, and 2129. Additional actuators (not shown) are typically present on other surfaces of the vest 2110. Fewer or more actuators can be present as desired. While not shown, actuators are typically present on posterior and anterior surfaces of the device that contacts the area to be treated. Each of the actuators 2121, 2122, 2123, 2124, 2125, 2126, 2127, 2128, and 2129 can be independently controlled and can provide the same or different vibratory force levels, can be operated at the same or different vibratory frequencies and may be electrically coupled to a processor (not shown) to control operation of each of the actuators 2121, 2122, 2123, 2124, 2125, 2126, 2127, 2128, and 2129. The actuators 2121, 2122, 2123, 2124, 2125, 2126, 2127, 2128, and 2129 can be the same or can be different. For example, each of the actuators 2121, 2122, 2123, 2124, 2125, 2126, 2127, 2128, and 2129 can independently be a linear resonant actuator, a piston, an eccentric rotating mass vibration motor, a linear rotor, a piezoelectric disk, a pneumatic device, a hydraulic device, a MEMS device, a micromotor, a nanomotor or other devices or materials that can provide a controllable vibratory force.

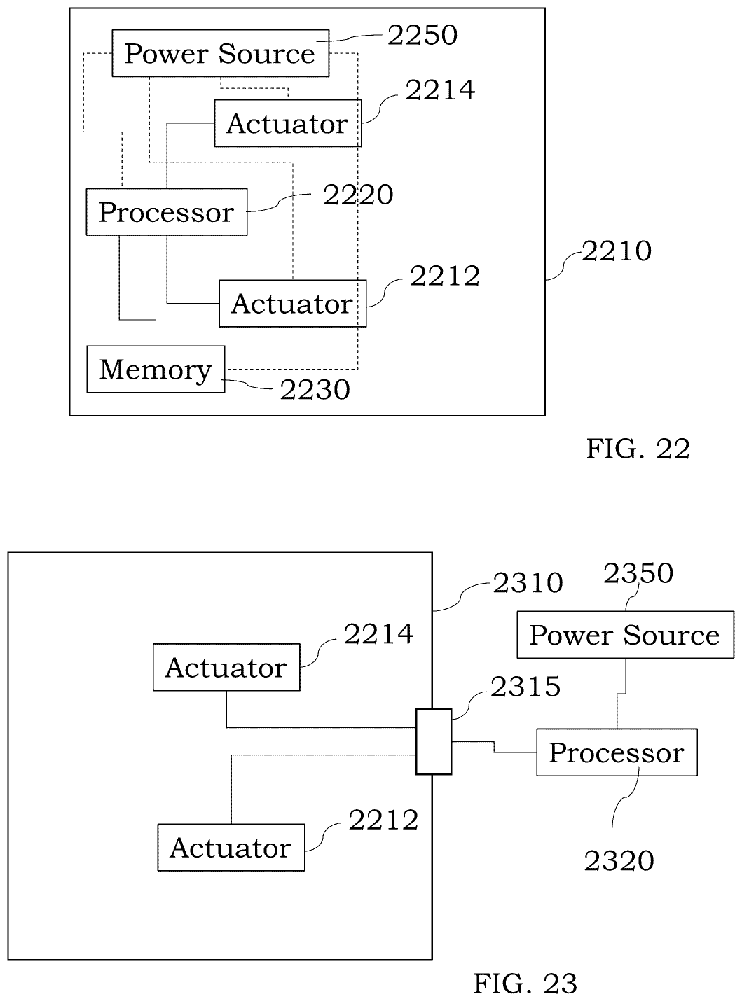

In certain embodiments, the actuators described herein can be electrically coupled to a processor or controller to provide for independent control of each actuator. For example, a clinician can customize vibration sequences for each patient to provide a tailored treatment protocol. A simplified illustration is shown in FIG. 22, where actuators 2212, 2214 in a substrate 2210 are shown as being electrically coupled to a processor 2220. While the processor 2220 is shown as being on or on-board the substrate 2210, if desired, the processor could instead be external to the substrate 2210. For example and referring to FIG. 23, a processor 2320 can be present on an external device that is configured to couple to a substrate 2310 through an electrical coupler 2315. The actuators 2212, 2214 can couple to the electrical coupler 2315 through various interconnects so the processor 2320 can independently control the actuators 2212, 2214 during use. The processor can also be electrically coupled to a memory unit 2230. As noted below, the memory unit 2230 can be a readable medium that can include instructions that when executed by the processor 2220 (or the processor 2320) causes the processor to control/actuate the individually controllable actuators in a substrate. The processor 2220 (or the processor 2320) may control the force provided by each actuator, the vibratory frequency provided by each actuator, a vibratory sequence provided by multiple actuators or other features of the actuator during treatment. A power source 2250 can be present in the substrate 2210 or where the processor is external to the substrate as shown in FIG. 23, the processor 2320 can be electrically coupled to an external power source 2350. The external power source 2350 can also provide power the actuators 2212, 2214 and any other components present in the substrate 2310 is desired.

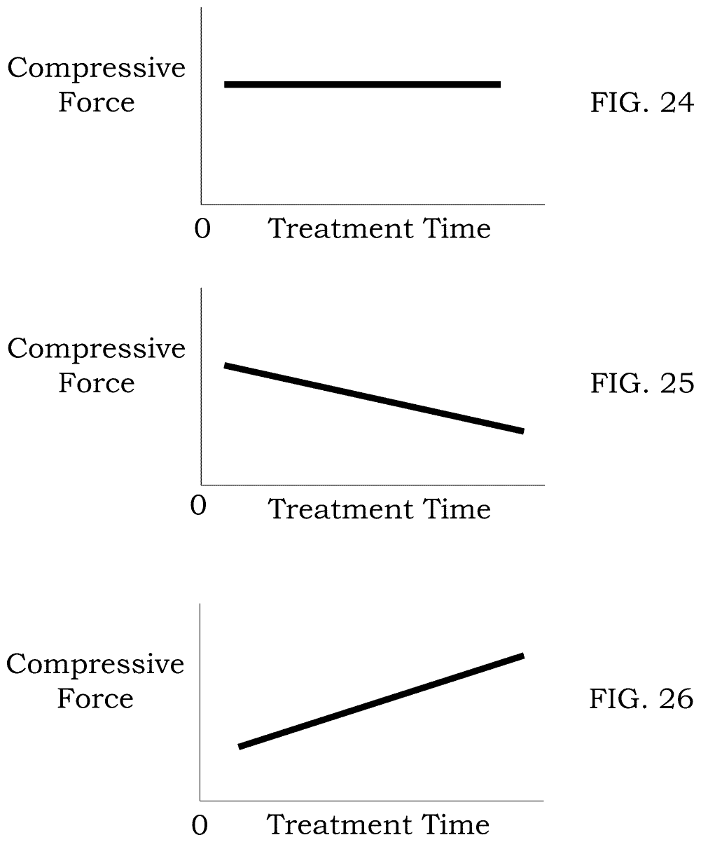

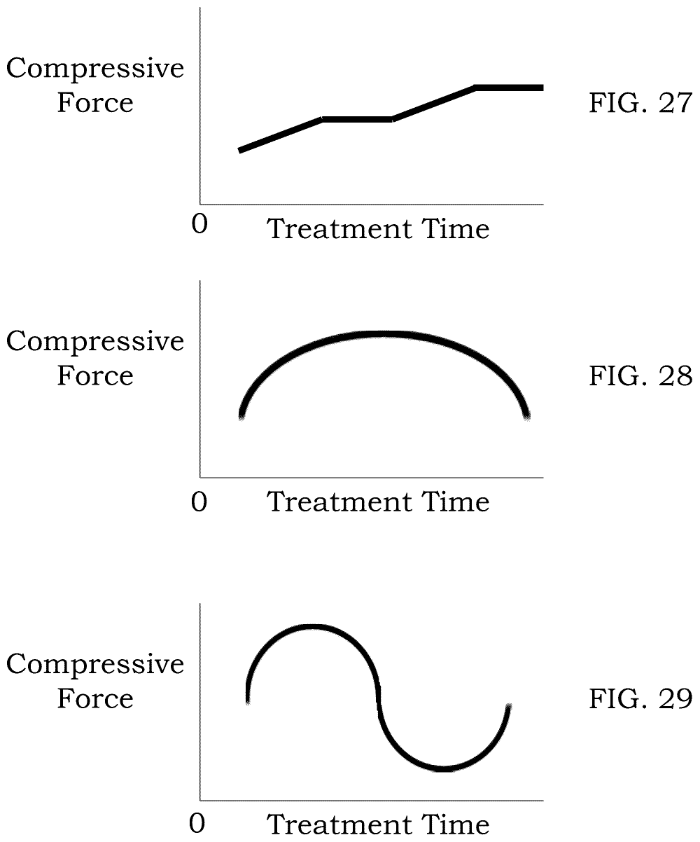

In certain embodiments, the devices described herein can be used to treat a disorder of a tissue or otherwise promote fluid flow into and/or out of the tissue. In use, the device is typically wrapped around the area to be treated or otherwise contacts the area. Compression from the substrate of the device can be provided during the treatment. The compression force/pressure during treatment may be constant over time (FIG. 24) or may vary during treatment (FIG. 25 and FIG. 26) at the same area of treatment. The level of compression can be selected or controlled by the clinician if desired. Where the compression force varies, the variation need not be linear but could be stepwise (as shown in FIG. 27), non-linear (FIG. 28), sinusoidal (FIG. 29) or may take other forms.

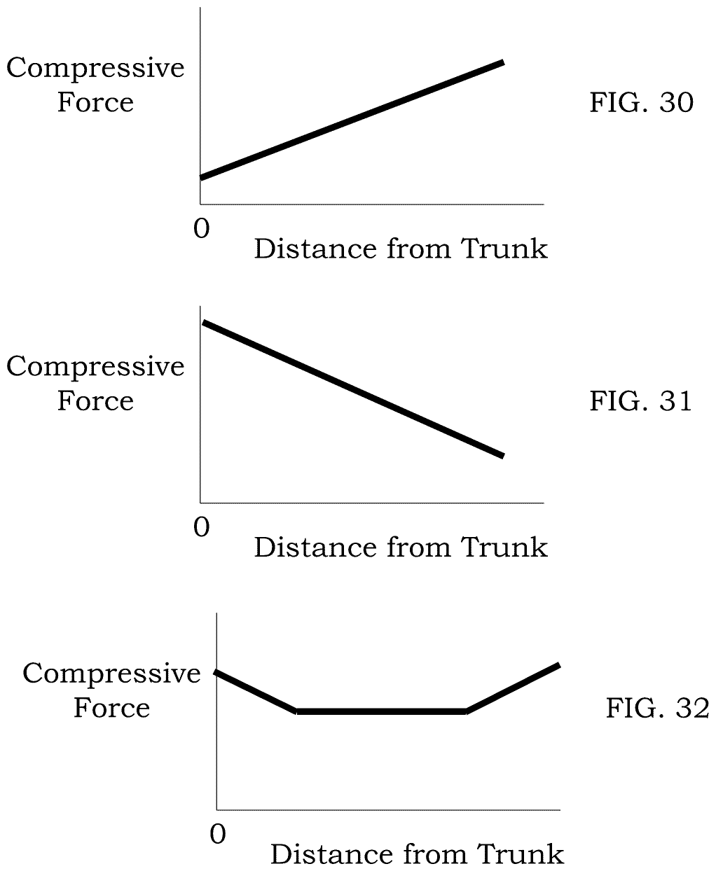

In certain configurations, the compression during treatment may be constant at any one area of the substrate but variable at different areas of the substrate. For example, a compressive force further away from a trunk, e.g., a torso, of the mammal may be greater than a compressive force closer to a trunk of the mammal (see FIG. 30). If desired, however, a compressive force further away from a trunk of the mammal may be less than a compressive force closer to a trunk of the mammal (FIG. 31). In other instances, the compressive force at distal ends of the substrate may be higher than a compressive force at a central area of the substrate (FIG. 32). The configuration of FIG. 32 may be particularly useful to retain an imaging agent, therapeutic, dye, etc. within the tissue for longer periods during treatment.

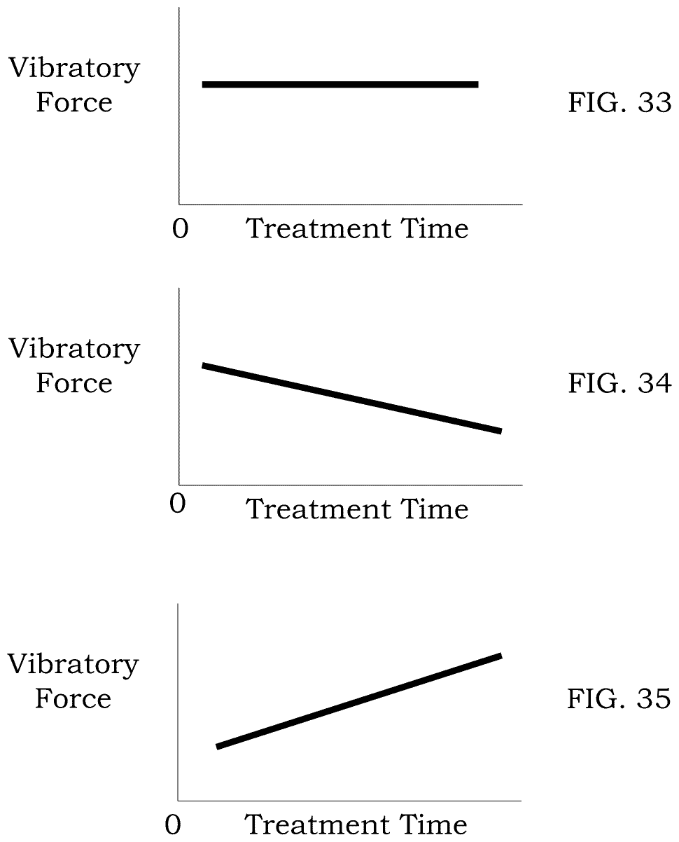

In certain embodiments, an average vibratory force provided by each actuator can vary or may be the same as desired. Further, an average vibratory force can vary during treatment for any one actuator. In some configurations, the average vibratory force for any one actuator may be constant (FIG. 33) during the treatment period, may decrease during treatment (FIG. 34) or may increase during treatment (FIG. 35). The average vibratory force for any one actuator can increase in a step-wise manner, may be altered in a non-linear manner or may be altered in a sinusoidal manner or other shapes.

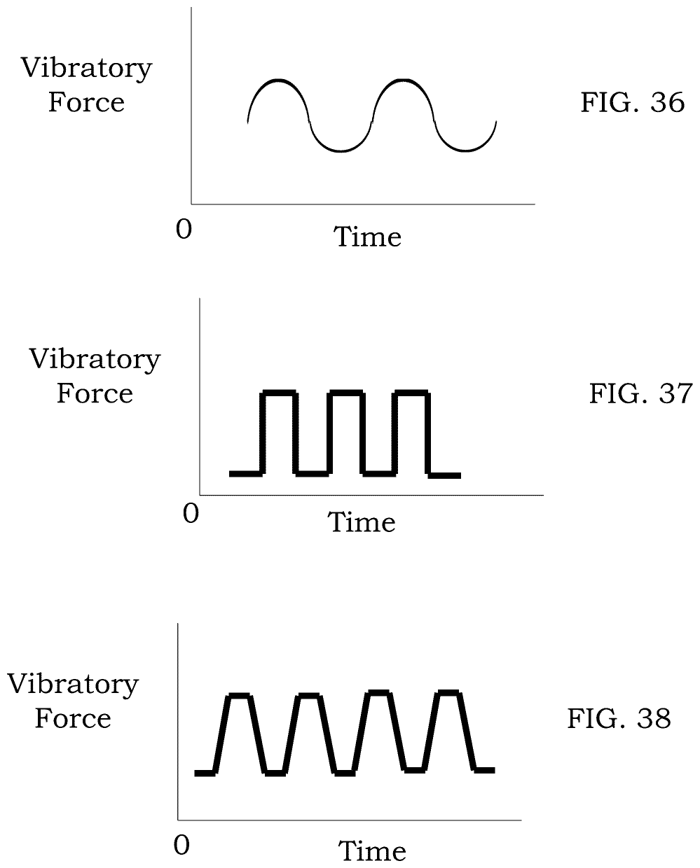

In some examples, the vibratory force can be provided to a contacted area in a pulsatile manner with a vibratory frequency that can vary, for example, from 10 Hz to about 300 Hz. The exact shape of the pulses may vary from sinusoidal (FIG. 36), square (FIG. 37), trapezoidal (FIG. 38) or other desired pulse shapes can be used. If desired, the actuator may be held in an “on” or extended position to provide a continuous force to the particular area adjacent to the actuator.

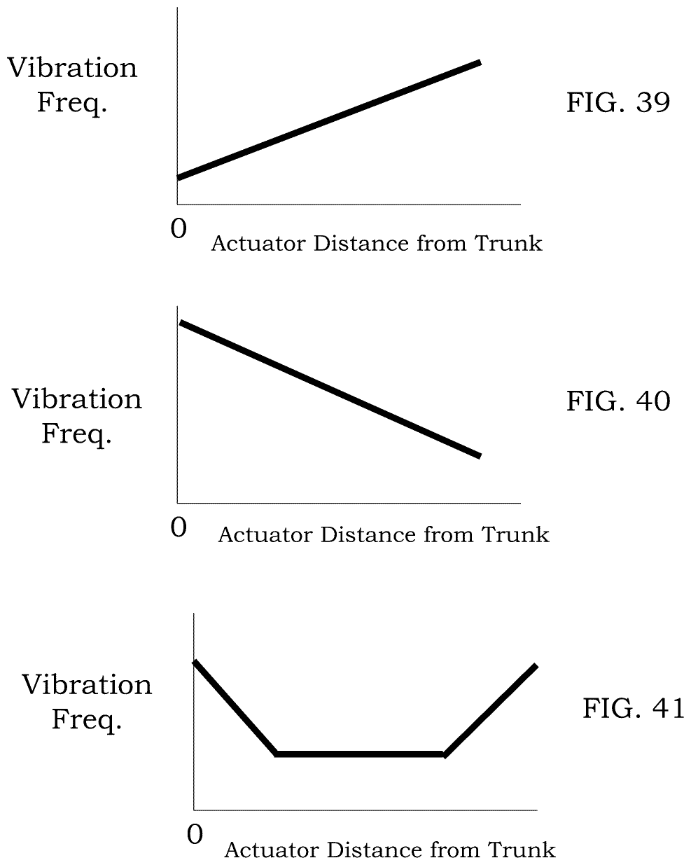

In some configurations, a vibratory frequency provided by different actuators can vary. It can be desirable, for example, when treating swelling to provide more vibrations at areas further away from a trunk of a mammal. The vibration frequency can increase (FIG. 39) for actuators positioned further away from the trunk of the mammal. Alternatively, the vibration frequency can decrease (FIG. 40) for actuators positioned further away from the trunk of the mammal. In some instances, the vibration frequency may be higher at each of a distal point adjacent to the trunk and at a distal point from the trunk (FIG. 41). This configuration can act to push fluid or other materials toward a central area surrounded by the substrate. The vibration frequency may also be changed during the treatment period so the vibration frequency of any one actuator is not necessarily constant during the treatment. Alteration of the vibration frequency during treatment can promote movement of fluid in a desired direction. As noted herein, a processor or controller can be used to control the actuation of the different actuators present in the substrate.

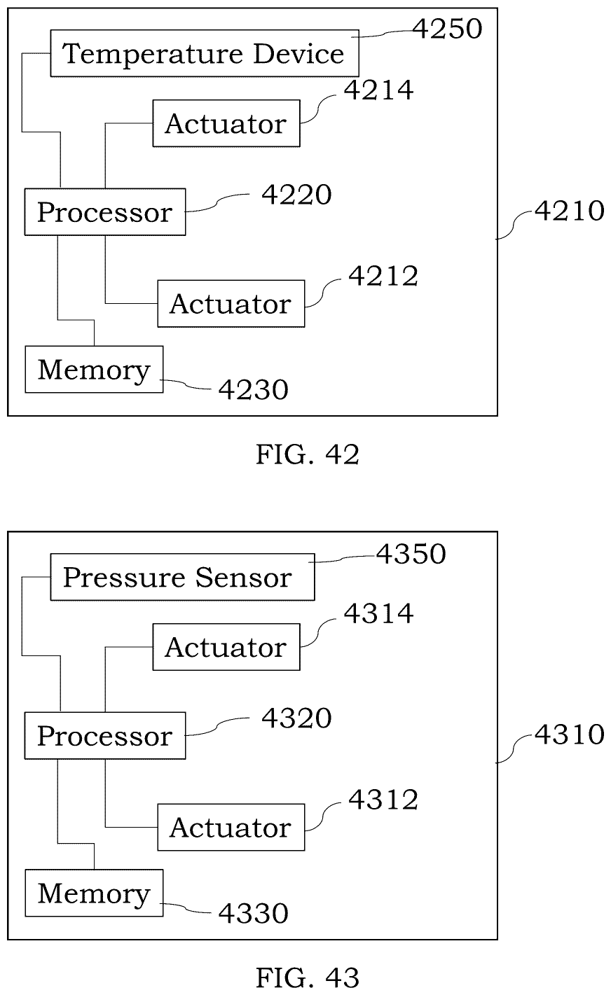

In certain embodiments and referring to FIG. 42, a device can include a substrate 4210, at least one actuator 4212, optionally a second actuator 4214, and a temperature control device 4250. An optional processor 4220 and memory unit 4230 may also be present and electrically coupled to the various electrical components. Alternatively, the processor can be present on a device which gets electrically coupled to the actuator 4212. The temperature control device can be operative to provide heat to the contacted area, can cool the contacted area or both. A temperature sensor may also be present to monitor the temperature of the underling tissue or organ.

In certain examples and referring to FIG. 43, a device can include a substrate 4310, at least one actuator 4312, optionally a second actuator 4314, and a pressure sensor 4350. An optional processor 4320 and memory unit 4330 may also be present and electrically coupled to the various electrical components. Alternatively, the processor can be present on a device which gets electrically coupled to the actuator 4312. The pressure sensor can be operative to sense an underlying pressure adjacent to the contacted area. As the contacted area is treated using the compression and/or vibratory forces, the swelling can decrease resulting in a drop in pressure between the substrate and the contacted area. The pressure sensor may be used as an indirect monitor that treatment of the area is effective.

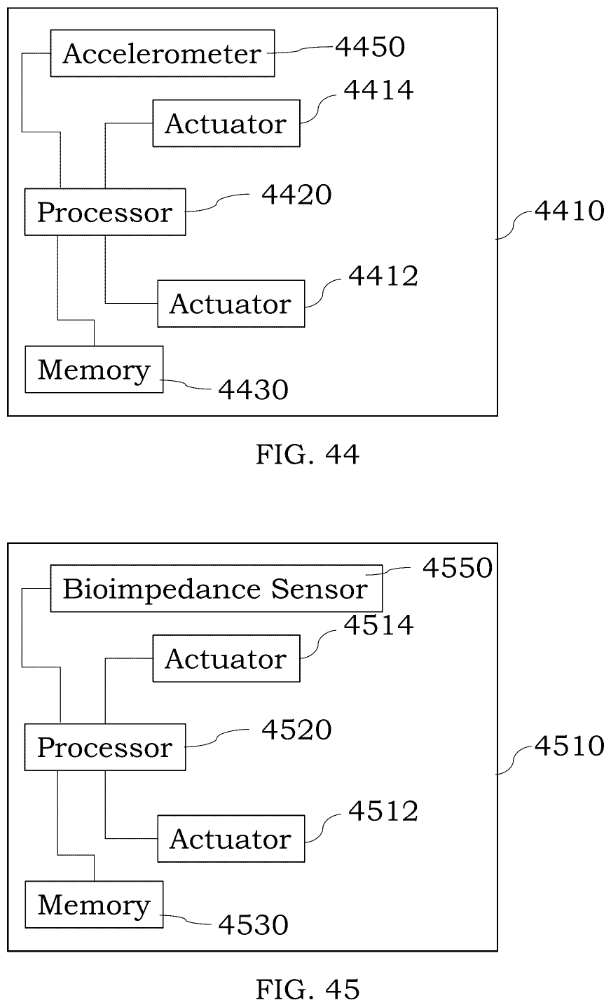

In certain configurations and referring to FIG. 44, a device can include a substrate 4410, at least one actuator 4412, optionally a second actuator 4414, and an accelerometer 4450. An optional processor 4420 and memory unit 4430 may also be present and electrically coupled to the various electrical components. Alternatively, the processor can be present on a device which gets electrically coupled to the actuator 4412. The accelerometer can be used to indirectly monitor the vibratory forces and/or frequencies being provided to the contacted area. For example, an accelerometer can be used to analyze the effect of varying vibration intensities at varying distances from vibration source.

In certain embodiments and referring to FIG. 45, a device can include a substrate 4510, at least one actuator 4512, optionally a second actuator 4514, and a bioimpedance sensor 4550. An optional processor 4520 and memory unit 4530 may also be present and electrically coupled to the various electrical components. Alternatively, the processor can be present on a device which gets electrically coupled to the actuator 4512. The bioimpedance sensor can be used, for example, to monitor fluid content and potentially provide real-time feedback of therapeutic effect.

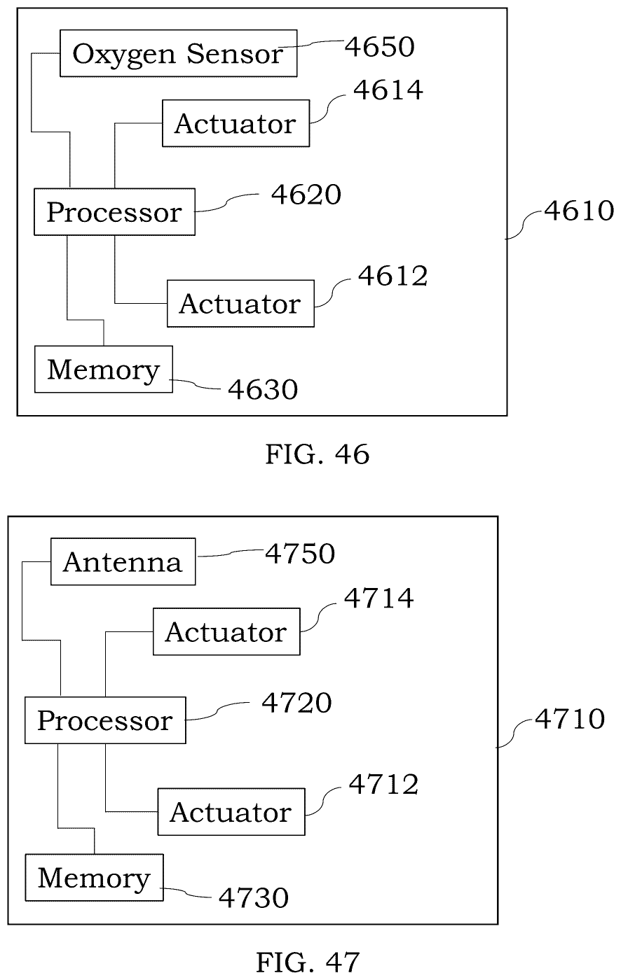

In certain examples and referring to FIG. 46, a device can include a substrate 4610, at least one actuator 4612, optionally a second actuator 4614, and an oxygen sensor 4650. An optional processor 4620 and memory unit 4630 may also be present and electrically coupled to the various electrical components. Alternatively, the processor can be present on a device which gets electrically coupled to the actuator 4612. The oxygen sensor can be used to monitor an oxygen level in the tissue adjacent to the oxygen sensor. As the contacted area is treated using the compression and/or vibratory forces, the level of oxygen in the area can change. This change may be used as an indirect monitor that treatment of the area is effective.

In certain configurations and referring to FIG. 47, a device can include a substrate 4710, at least one actuator 4712, optionally a second actuator 4714, and an antenna 4750. An optional processor 4720 and memory unit 4730 may also be present and electrically coupled to the various electrical components. Alternatively, the processor can be present on a device which gets electrically coupled to the actuator 4712. The antenna 4750 can be used to communicate with the processor 4720 and can send/receive communications to/from a remote device or system. Treatment using the device can also be remotely monitored through the antenna 4750.

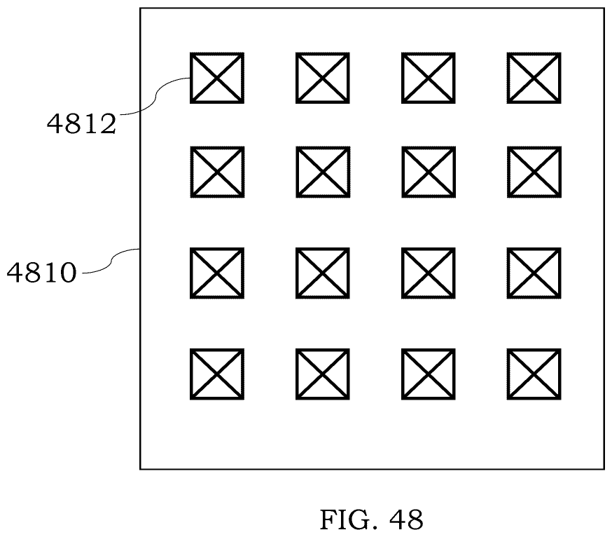

In certain embodiments, the substrate may comprise a plurality of individual sites that can receive an actuator. Referring to FIG. 48, a site 4812 on a substrate 4810 is shown. The site 4812 can include an electrical connection and/or coupler that can receive a removable actuator. The presence of multiple sites permits an end user to position the actuators at desired sites to provide a customizable substrate. Non-occupied sites can be covered with an insulating material or blank prior to using the substrate 4810 for treatment.

The systems described herein typically include at least one processor and optionally a memory unit, storage or other electrical components. The processor may be a stand-alone processor or can be part of a larger controller such as, for example, an Arduino Uno microcontroller. The processor can cause the treatment to be performed automatically without the need for user intervention or a user may enter parameters through a user interface present on a mobile device, a terminal, a display, a screen or other suitable interfaces to input the particular treatment parameters, e.g., vibratory forces, vibratory frequencies, treatment times, etc. In certain configurations, the processor may be present in one or more computer systems and/or common hardware circuitry including, for example, a microprocessor and/or suitable software for operating the system. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple A11 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, authorized users, etc. during operation of the system. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. The processor typically is electrically coupled to a power source which can, for example, be a direct current source, an alternating current source, a battery, a fuel cell or other power sources or combinations of power sources. In a typical configuration, the processor is configured to use 110 Volts AC. The power source can be shared by the other components of the system. The system may also include one or more input devices, for example, a keyboard, mouse, trackball, microphone, touch screen, manual switch (e.g., override switch) and one or more output devices, for example, a printing device, display screen, lights, speaker. As noted herein, the system may contain one or more communication interfaces, e.g., a WiFi antenna, a Bluetooth antenna, a cellular antenna or non-cellular antenna, that connect the device to a communication network (in addition or as an alternative to the interconnection device). The antenna can be used, for example, to remotely monitor treatment using the devices or to send signals to and from the device for control of the various actuators. The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

The computer readable medium typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may also be implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8, Windows 10 or Windows 11 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system. In some instances, a simple set of commands may be present on a memory unit of the substrate and can be updated from time to time using one or more wired connectors or a wireless connection.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the system may comprise a software interface on a remote system that can couple to the device in a wired or wireless manner. For example, instructions can be entered into an electronic medical records database and transmitted to the processor used with the device over a wired or wireless network. The instructions stored in the memory can execute a software module or control routine for the system, which in effect can provide a controllable model of the system. Alternatively, application software can be present on a mobile device that can communicate with the device to provide a desired treatment routine, e.g., to provide desired vibratory forces and/or a desired vibratory force pattern. If desired, application software may be customized and provided to a patient along with educational information or a treatment regimen, e.g., including use of the device, exercises, etc., designed to treat lymphedema, pain, swelling or other disorders of the patient.

In certain embodiments, the various devices described herein can be used to treat an area of a mammal experiencing swelling. For example, the device can contact the area, e.g., be wrapped around the area or placed around the area, and be used to provide a compressive force and/or a vibratory force at an effective level to reduce the swelling. As noted herein, the compressive forces and vibratory forces at different areas of the device (and correspondingly different areas of the tissue) may be constant or may vary. In some embodiments where swelling is treated, actuators further away from a trunk area of the mammal can be actuated to provide a higher vibratory force, can be actuated at higher vibratory frequencies or both as compared to the vibratory force and the vibratory frequencies used with actuators closer to the trunk of the mammal. This arrangement acts to force fluid from the distal areas of the tissue toward the trunk to reduce swelling and/or promote drainage at the treated site. Each of the actuators in the substrate can be individually controlled during treatment. A customized treatment protocol can be created for each patient to achieve a desired level of treatment.

In some embodiments, the devices described herein can be used to treat lymphedema of the head, neck, arm, groin, hand, foot or other organs or tissues. In some instances, the device can be particularly useful at treating head and neck lymphedema after cancer treatments. For example, the devices can be used with cancer patients for complete decongestive therapy. The device is generally placed on or around the head and/or neck of the patient and used to provide compression and a vibratory force. The substrate can be adjustable as shown in FIG. 1 to permit the level of compression to be adjusted and/or to permit the substrate to be adjusted to fit the size of the head and neck of different patients.

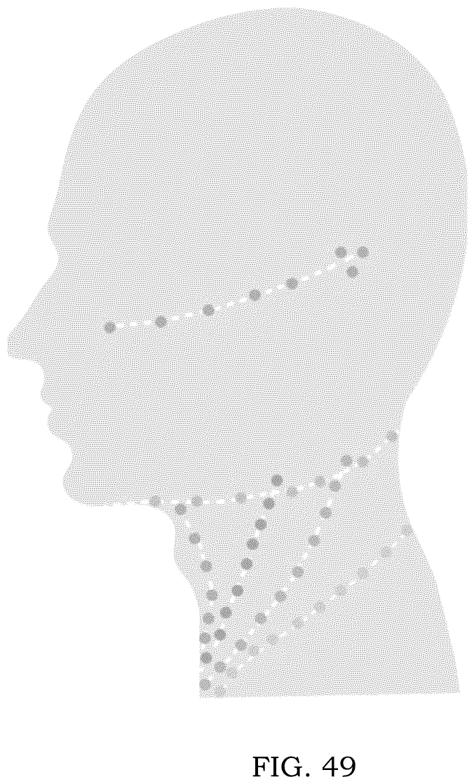

The exact placement of the actuators on the patient can vary. In some embodiments, the actuators can be placed on, adjacent to or near lymph nodes. For example and referring to FIG. 49, an illustration is shown with dots indicating where actuators may be placed to treat lymphedema of the head and neck. The actuators can be placed over occipital, anterior cervical and supraclavicular lymph nodes to promote drainage/fluid flow.

Compressive forces and vibratory forces at different areas of the device (and correspondingly different areas of the head/neck) may be constant or may vary. Actuators further away from the neck can be actuated to provide a higher vibratory force, can be actuated at higher vibratory frequencies or both as compared to the vibratory force and the vibratory frequencies used with actuators closer to the neck. This arrangement acts to force fluid from the head into the neck and toward the trunk to reduce lymphedema of the head and neck. Each of the actuators in the head/neck device can be individually controlled during treatment.

In certain configurations, the devices described herein can be used to promote fluid movement into and/or out of tissues which can assist, for example, in enhancing athletic performance and/or reducing soreness. In some instances, the device can contact the area, e.g., be wrapped around the area or placed around the area, and be used to provide a compressive force and a vibratory force at an effective level to promote flow of fluid into and/or out of the contacted area. The compressive forces and vibratory forces at different areas of the device (and correspondingly different areas of the tissue) may be constant or may vary. In some embodiments where fluid flow is promoted, actuators further away from a trunk area of the mammal can be actuated to provide a higher vibratory force, can be actuated at higher vibratory frequencies or both as compared to the vibratory force and the vibratory frequencies used with actuators closer to the trunk of the mammal. This arrangement can then be reversed if desired to move fluid into the tissue from the trunk. Each of the actuators in the substrate can be individually controlled during use to promote fluid flow.

In other embodiments, the devices described herein can be used to treat one or more of localized pain, neuropathy, fibromyalgia, wound healing, bone healing, muscle healing, covid recovery (decreasing protein molecules and activating intercostal muscles), cystic fibrosis, Lyme disease, or other disorders where it can be desirable to promote fluid flow and/or promote lymphatic drainage. Such treatment may be accomplished using vibration, compression or both.

In some examples, the vibratory/compression device can be used in combination with percussive massage techniques. For example, percussive massage can be used to provide deeper tissue stimulation, while the vibratory/compression devices can provide surface stimulation and compression. The vibratory/compression device can be used before or after percussive massage therapy or simultaneously with percussive massage therapy for enhanced tissue stimulation at superficial and deep areas. Illustrative percussive massage devices include those commercially sold as Theragun™ devices and similar percussive devices.

In certain embodiments, application software including the treatment protocol can be provided along with a device to permit an end user to use the device in an at home setting. The application software provides, wherein the instructions when executed by a processor, cause the processor to independently actuate one or more individually controllable actuators to provide a vibratory force to reduce swelling, treat pain or provide some other desired result to the subject being treated. The application software can be customized and/or varied over a treatment period by altering the software or selecting different sub-routines as advised by the clinician based on results achieved from prior treatments.

Certain specific examples are described to illustrate some of the aspects and features of the technology described herein.

### Example 1

A device was constructed consisting of 16 motors present in a sleeve designed to be placed over a human arm. This device was compared to two vibratory devices as noted below. In the test device, 8 motors were positioned on the posterior side of the sleeve and 8 motors were positioned on an anterior side of the sleeve. The 8 motors on the anterior side were connected in parallel, and the 8 motors on the posterior side were connected in parallel. Opposing motors in the same radial plane were placed in series. Each motor was present in a silicone casing and was operated using a 6 Volt DC power supply. Each motor was an eccentric rotating mass motor.

The hardware used included an Adafruit Feather 32u4 with Bluetooth and an Arduino compatible microcontroller to control the motors by the Adafruit DC Motor+Stepper FeatherWing. The FeatherWing contained a PCA9685 16-channel PWM controller connected to a TB6612FNG motor driver. The motor housing featured a unique, semi-ovoid silicone mold designed to distribute the vibration farther as well as a ensure a softer feel for the patient, as opposed to the motor being directly on the arm. The motor fits snugly in the middle, and has room for the wires to exit out of either side. The motor housing is approximately 1.75×2.5×1 inches. The motor is a 3 Volt DC vibration motor that is approximately 1×0.5×0.5 inches.

### Example 2

The device of Example 1 was used to provide simultaneous compressive and vibratory forces. The motors were operated in discrete pairs. Both the anterior and posterior motor pair will run simultaneously with decreasing intensity as the sequence moves proximally toward an area of the sleeve intended to be near the shoulder.

There were both warm up and clearing sequences. The device was divided into the upper and lower arm. The lower arm consisted of anterior and posterior motors 1-4, while the upper arm consisted of anterior and posterior motors 5-8. The upper and lower arm both had their own programming to run both the clearing and warm up sequences. However, there are also warm up and clearing sequences for the entire arm.

In the warm up pattern used for each of the upper arm and the lower arms, distal motors were first actuated and then switched off followed by actuation of each motor pair more proximate to the shoulder area of the sleeve. The motor pairs were switched on/off for 3 seconds. This pattern was repeated 5×.

For clearing of swelling, the motors were actuated in a gradient manner so more vibrations occurred at areas more distal from the shoulder. For example, a motor pair adjacent to the wrist was actuated at a higher vibratory frequency that a motor pair adjacent to the elbow. The motors were sequentially activated to mimic a manual pushing motion of pushing fluid first from the wrist and gradually toward the elbow.

### Example 3

The motors can be operated using the Pulse Width Modulation from the controller using the PWM pin in the controller. The PWM pin permitted varying the average voltage experienced by the motors. For this experiment, the motors were tested at speeds ranging from 100% to 50% at 10% increments. PWM ranges from 0 to 255, therefore the 100% and 50% motor speeds correspond to PWMs of 255 and 128, respectively.

A singular motor was placed in the bottom of the compression sleeve surrounding the arm phantom and an accelerometer was placed 75 mm from the motor. The motor was turned on and the magnitude of acceleration and frequency were collected using the MetaBase app. This process was repeated after moving the accelerometer to 85, 95, and 105 mm from the motor. The entire process was repeated using three other motors in order to account for any manufacturing variability in the motors.

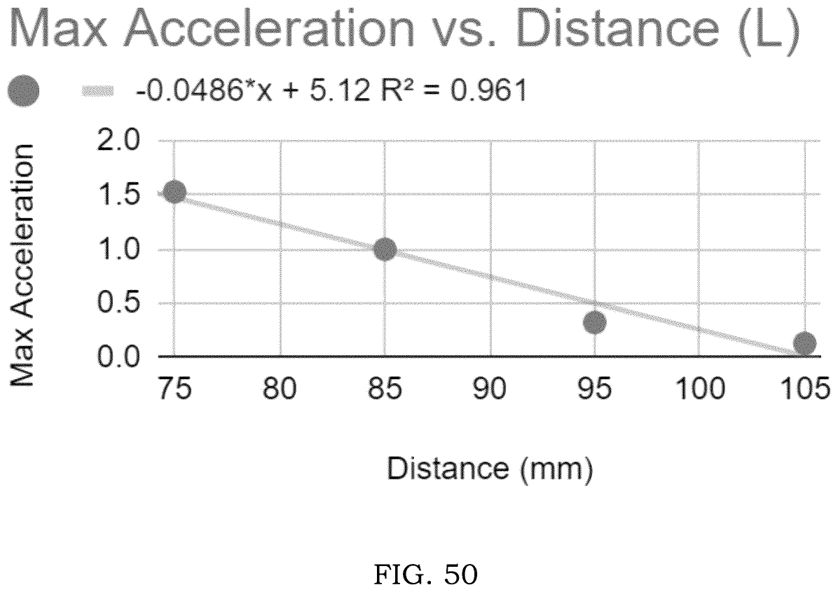

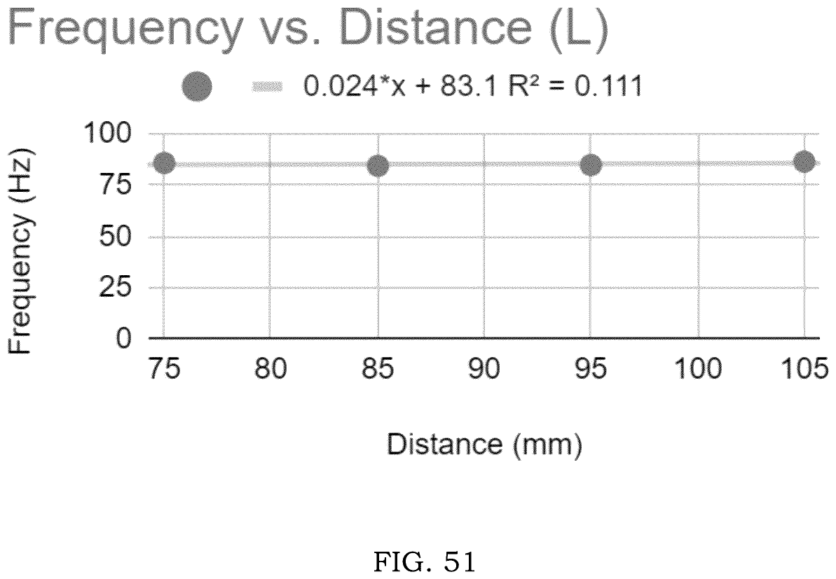

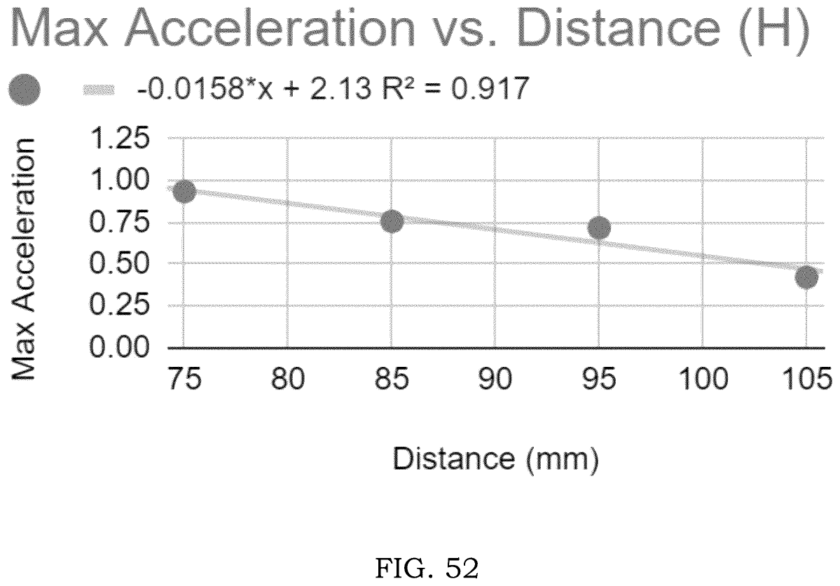

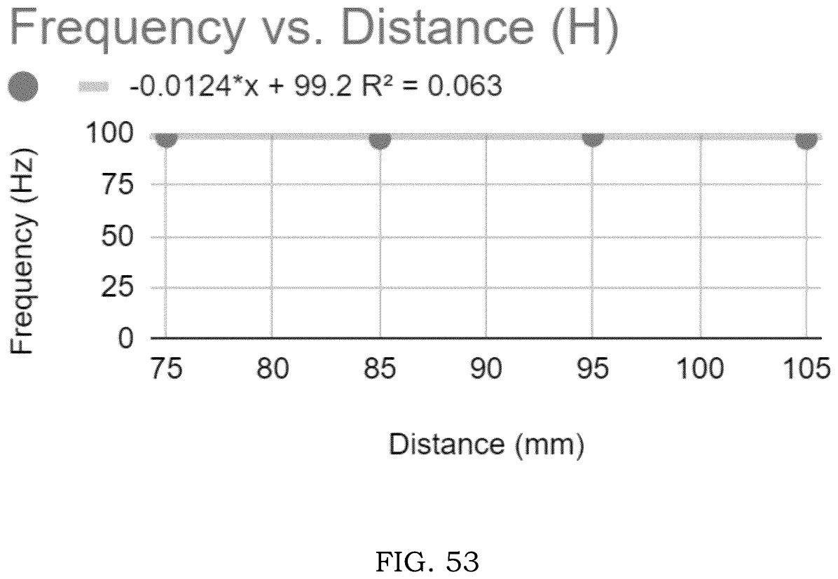

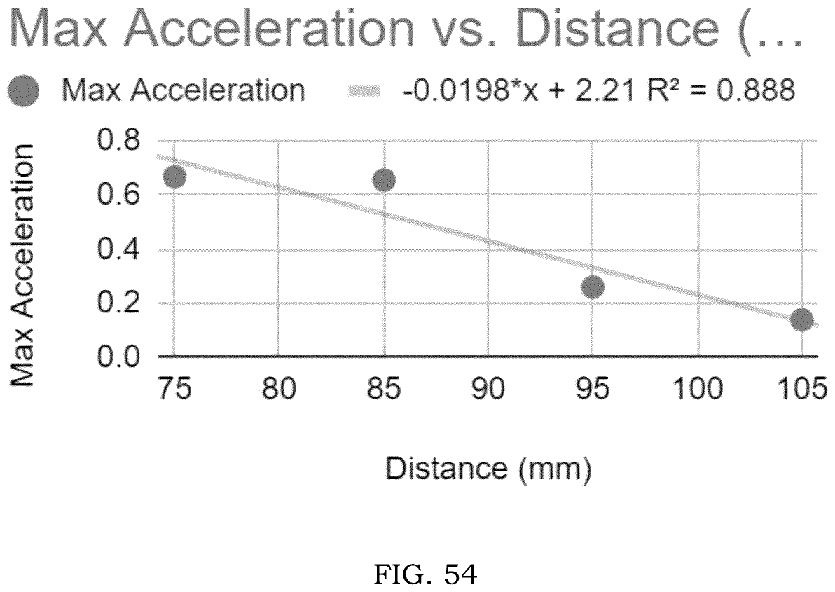

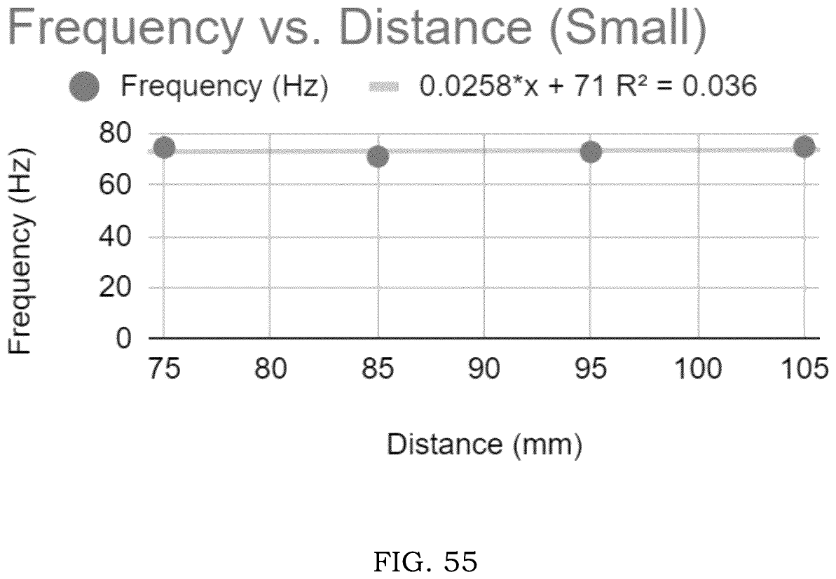

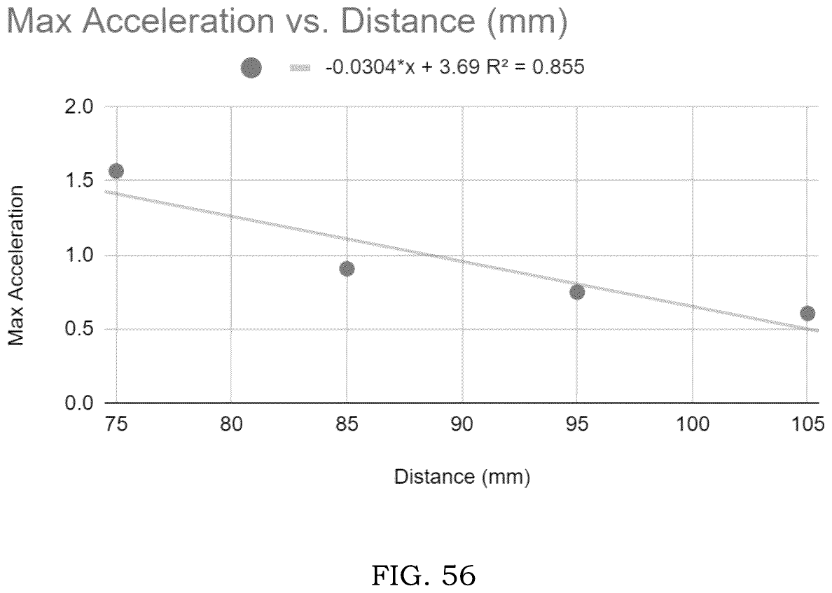

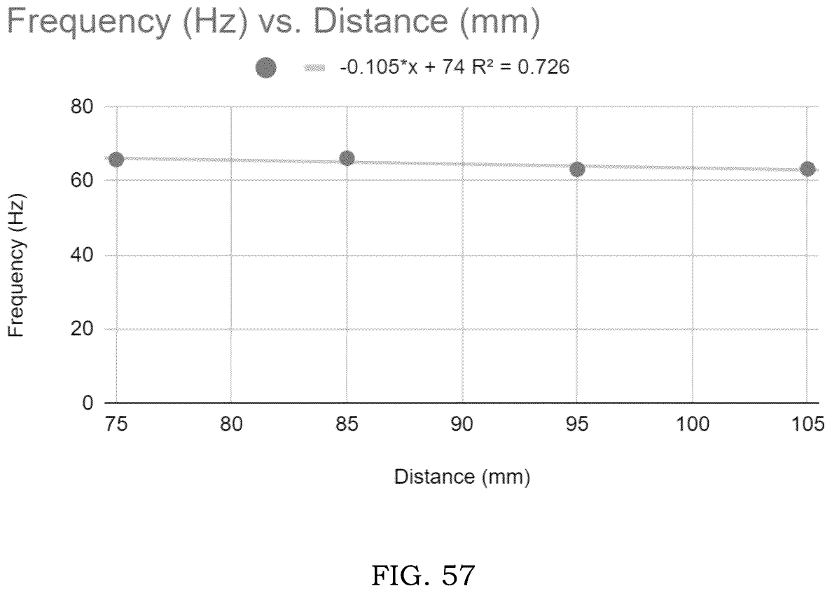

For comparison a large vibratory device (Magic Wand® Original personal massager) was used on a high setting (6000 rpm or about 100 Hz) and on a low setting (5000 rpm or about 83 Hz) at a similar site as the test motor. A small vibratory device was also used (Mini Massager by North Coast Medical) with a frequency of about 92 Hz. The results of testing the large and small vibratory devices and the motor are shown in FIGS. 50-57. FIGS. 50 and 51 correspond to the large vibrator (Magic Wand® Original personal massager) at the low setting (5000 rpm). FIGS. 52 and 53 correspond to a large vibrator (Magic Wand® Original personal massager) at the high setting (6000 rpm). FIGS. 54 and 55 correspond to the small vibrator (Mini Massager). FIGS. 56 and 57 correspond to one of the test motors operated at 255 PWM.

The large vibrator (high and low settings-FIGS. 50-53), small vibrator (FIGS. 54, 55) and the one motor (FIGS. 56, 57) all produced a negative correlation between maximum acceleration and distance from an accelerometer. These results are consistent with using an accelerometer to monitor gradient vibratory forces provided along the sleeve. The results are also consistent with there being no correlation between frequency and distance from an accelerometer.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A device comprising:
a substrate configured to contact an area of a mammal; and
one or more individually controllable actuators in the substrate, wherein the one or more individually controllable actuators are each configured to provide a vibratory force to a portion of the contacted area of the mammal.

2. The device of claim 1, further comprising a processor electrically coupled to the one or more individually controllable actuators.

3. The device of claim 2, wherein the substrate is configured to provide a compressive force to the area of the mammal contacted by the substrate.

4. The device of claim 1, wherein the substrate is conformable.

5. The device of claim 1, wherein the substrate is configured as a wrap comprising a fastener to retain the wrap around the area.

6. The device of claim 2, further comprising a temperature control device in the substrate, wherein the temperature control device is electrically coupled to the processor.

7. The device of claim 1, wherein the vibratory force is configured as a non-percussive vibratory force.

8. The device of claim 2, wherein the processor is programmed to actuate actuators distal from a trunk of the mammal at a higher frequency or to provide a greater vibratory force than actuators proximate to the trunk of the mammal.

9. The device of claim 1, wherein at least one of the one or more individually controllable actuators comprises a linear resonant actuator.

10. The device of claim 1, wherein the substrate comprises a cooling material.

11. The device of claim 2, wherein at least one of the one or more of the individually controllable actuators provides a vibratory frequency to the contacted area from about 10 Hz to about 300 Hz.

12. The device of claim 2, wherein the processor is configured to vary an intensity of the vibratory force to reduce swelling at the contacted area.

13. The device of claim 2, further comprising a pressure sensor within the substrate, wherein the pressure sensor is electrically coupled to the processor and is configured to monitor pressure at the contacted area.

14. The device of claim 2, further comprising an accelerometer within the substrate, wherein the accelerometer is electrically coupled to the processor and is configured to monitor a frequency of the vibratory forces provided by the one or more individually controllable actuators.

15. The device of claim 2, wherein at least one of the one or more individually controllable actuators comprises one or more of a linear resonant actuator, a piston, an eccentric rotating mass vibration motor, a linear rotor, a piezoelectric disk or a hydraulic device.

16. The device of claim 2, wherein at least one of the one or more individually controllable actuators is configured as a MEMS device.

17. The device of claim 2, further comprising a bioimpedance sensor in the substrate, wherein the bioimpedance sensor is configured to monitor fluid content at the contacted area.

18. The device of claim 2, wherein a position of the one or more individually controllable actuators within the substrate is variable.

19. The device of claim 2, wherein the substrate comprises a reverse gelling material to increase compression at the contacted area when the reverse gelling material is heated by the contacted area.

20. The device of claim 1, wherein the substrate is configured to contact external surfaces of an organ of the mammal.

21-70. (canceled)
